(19) United States
(12) Patent Application Publication
(10) Pub. No.: US 2025/0097797 A1
(43) Pub. Date: Mar. 20, 2025

(54) METHODS AND APPARATUSES FOR MRO FOR PSCELL CHANGE OR CPAC IN NR-U

(71) Applicant: Lenovo (Beijing) Limited, Beijing (CN)

(72) Inventors: Le Yan, Shanghai (CN); Mingzeng Dai, Shanghai (CN); Lianhai Wu, Beijing (CN); Yibin Zhuo, Beijing (CN); Congchi Zhang, Shanghai (CN)

(73) Assignee: Lenovo (Beijing) Limited, Beijing (CN)

(21) Appl. No.: 18/726,708

(22) PCT Filed: Jan. 6, 2022
(86) PCT No.: PCT/CN2022/070516

§ 371 Date: Jul. 3, 2024

(51) Int. Cl. H04W 36/08; H04W 36/00; H04W 36/24; H04W 36/30

(52) U.S. Cl. CPC H04W 36/08; H04W 36/0079; H04W 36/24; H04W 36/305

(57) ABSTRACT

The present application relates to methods and apparatus for MRO for PSCell change or CPAC in NR-U. One embodiment of the present disclosure provides a master node (MN), comprising: a transceiver; and a processor coupled to the transceiver, wherein the transceiver is configured to receive first information related to downlink (DL) listen before talk (LBT) failure from a first secondary node (SN), and/or second information related to uplink (UL) LBT failure associated with secondary cell group (SCG) failure from one of: a user equipment (UE), or a third node, or a second SN; and wherein the processor is configured to determine whether or not to transfer the first information and/or the second information to the second SN for the second SN to perform a SCG failure type detection.

### TECHNICAL FIELD

The present disclosure relates to wireless communication in new radio unlicensed (NR-U) spectrum, and more specifically relates to methods and apparatus for mobility robustness optimization (MRO) for primary SCG cell (PSCell) change or conditional PSCell addition/change (CPAC) in NR-U.

### BACKGROUND OF THE INVENTION

NR-U feature is introduced in Rel-16, and the user equipment (UE) can operate in the unlicensed spectrum with the PCell, PSCell and SCells.

In NR-U, any type of transmission can be transmitted in the unlicensed spectrum. Before transmitting on the unlicensed spectrum, both the UE and the gNB should perform the listen before talk (LBT) procedure and/or sense the wireless channel, in order to ensure that the wireless channel is not occupied by other transmissions which could be generated by non-3GPP technologies such as WiFi.

However, the LBT procedure or channel sensing may not always have a successful result, and the PSCell change or CPAC in NR-U may fail due to the LBT failure at UE side, or due to channel resources at network side are unavailable. Therefore, it is necessary to improve the MRO for PSCell change or CPAC in NR-U.

### SUMMARY

It is desirable to provide solutions for MRO for PSCell change or CPAC in NR-U.

One embodiment of the present disclosure provides a master node (MN), comprising: a transceiver; and a processor coupled to the transceiver, wherein the transceiver is configured to receive first information related to downlink (DL) listen before talk (LBT) failure from a first secondary node (SN), and/or second information related to uplink (UL) LBT failure associated with secondary cell group (SCG) failure from one of: a user equipment (UE), or a third node, or a second SN; and wherein the processor is configured to determine whether or not to transfer the first information and/or the second information to the second SN for the second SN to perform a SCG failure type detection.

In an embodiment, the transceiver is further configured to: transfer the first information and/or the second information to the second SN in the case that a failure occurred in primary secondary cell (PSCell) change procedure or conditional PSCell Addition/Change (CPAC) procedure initiated by the second SN.

In an embodiment, the processor is further configured to: perform the SCG failure type detection based on the first information and/or the second information in the case that the failure occurred in PSCell change procedure or CPAC procedure initiated by the MN.

In an embodiment, the transceiver is further configured to: transmit a first message to the first SN to inform that SCG failure occurred due to LBT failure.

In an embodiment, the transceiver is further configured to: receive third information related to UL LBT failure associated with master cell group (MCG) failure from the second SN or the third node; and wherein the processor is further configured to: perform the SCG failure type detection and MCG failure type detection based on the second information and the third information, or based on the first information and the third information.

In an embodiment, the processor is further configured to: modify LBT related configurations associated with MCG and/or transmit a first message to the first SN to inform that SCG failure occurred due to LBT failure.

In an embodiment, the transceiver is further configured to: receive a second message from the first SN regarding which node initiates the PSCell change procedure or the CPAC procedure; and transmit a first response to the first SN indicating a SN initiates PSCell change procedure or the CPAC procedure, wherein the first information is received from the first SN after transmitting the first response; or a second response to the first SN indicating that the MN initiates PSCell change procedure or the CPAC procedure.

In an embodiment, the transceiver is further configured to: receive a second message from the first SN indicating that LBT related configurations associated with SCG have been modified.

In an embodiment, the first information includes at least one of the following:
1) a 1^{st} indication indicating that PSCell change failure or CPAC failure occurred due to LBT failure at the first SN, or due to new radio unlicensed (NR-U) channel(s) in target PSCell managed by the first SN are unavailable;
2) a PSCell change or CPAC failure type;
3) a 2^{nd} indication indicating that LBT related configurations associated with SCG needs to be modified;
4) information associated with NR-U channel(s) which are unavailable;
5) information associated with LBT events in target PSCell;
6) a Received Signal Strength Indicator (RSSI) of the target PSCell when LBT fails or when the NR-U channels in target PSCell are unavailable; or
7) a channel occupancy of the target PSCell when LBT fails or when the NR-U channels in target PSCell are unavailable.

In an embodiment, the second information includes at least one of the following:
1) a 3^{rd} indication indicating that PSCell change failure or CPAC failure occurs due to LBT failure;
2) a PSCell change or CPAC failure type;
3) one or more UL Bandwidth Part (BWP) IDs on the target PSCell where LBT failure occurs;
4) the number of target PSCell's UL BWPs where consistent LBT failure occurs;
5) the number of LBT failures detected in a Media Access Control (MAC) entity for target PSCell for each BWP;
6) a Received Signal Strength Indicator (RSSI) of the target PSCell; or
7) a channel occupancy of the target PSCell.

In an embodiment, the third information includes at least one of the following:
1) a 4^{th} indication indicating that MCG failure occurs due to LBT failure;
2) a MCG failure type;
3) one or more UL BWP IDs on the source PCell where LBT failure occurs;
4) the number of source PCell's UL BWPs where consistent LBT failure occurs;
5) the number of LBT failures detected in a MAC entity for source PCell for each BWP;
6) a Received Signal Strength Indicator (RSSI) of the source PCell; or
7) a channel occupancy of the source PCell.

Another embodiment of the present disclosure provides a first secondary node (SN), comprising: a transceiver; and a processor configured with the transceiver, wherein the transceiver is configured to receive first information related to downlink (DL) listen before talk (LBT) failure, and/or second information related to uplink (UL) LBT failure associated with secondary cell group (SCG) failure; and wherein the processor is configured to perform a SCG failure type detection based on the first information and/or the second information.

In an embodiment, the transmitter is further configured to: transmit a first message to a second SN to inform that SCG failure occurred due to LBT failure; or transmit the first message to a master node to inform that SCG failure occurred due to LBT failure or to indicate the master node to inform the second SN that SCG failure occurred due to LBT failure.

In an embodiment, the transceiver is further configured to: transmit third information related to UL LBT failure associated with master cell group (MCG) failure to a master node.

Yet another embodiment of the present disclosure provides a first secondary node (SN), comprising: a transceiver; and a processor configured with the transceiver, wherein the processor is configured to determine first information related to downlink (DL) listen before talk (LBT) failure; and wherein the transceiver is configured to transmit the first information to a master node.

In an embodiment, the processor is further configured to: modify LBT related configurations associated with SCG; and/or wherein the transceiver is configured to transmit a first message to the master node indicating that the LBT related configurations associated with SCG of the node are modified.

In an embodiment, the transceiver is further configured to: receive a second message indicating that SCG failure occurred due to LBT failure.

In an embodiment, the transceiver is further configured to: transmit a third message to a master node (MN) regarding which node initiates the PSCell change procedure or the CPAC procedure; and receive a first response indicating that a second SN initiates PSCell change procedure or the CPAC procedure, wherein the first information is transmitted to the master node after receiving the first response; or a second response indicating that the MN initiates PSCell change procedure or the CPAC procedure.

Still another embodiment of the present disclosure provides a user equipment (UE), comprising: a transceiver; and a processor configured with the transceiver, wherein the transceiver is configured to receives one or more triggering conditions associated with NR-U for a successful PSCell change report; and wherein the processor is configured to generate a successful PSCell change report when at least one triggering condition of the one or more triggering conditions is fulfilled.

In an embodiment, wherein the one or more triggering conditions includes at least one of the following:
1) LBT failure occurs in at least one UL BWP on a source PCell;
2) LBT failure occurs in at least one UL BWP on a source PSCell;
3) LBT failure occurs in at least one UL BWP on a target PSCell;
4) a 1^{st} number of source PCell's UL BWPs where consistent LBT failure occurs is higher than a 1^{st} threshold;
5) a 2^{nd} number of source PSCell's UL BWPs where consistent LBT failure occurs is higher than a 2^{nd} threshold;
6) a 3^{rd} number of target PSCell's UL BWPs where consistent LBT failure occurs is higher than a 3^{rd} threshold;
7) a 4^{th} number of LBT failure indications received from physical layer in the MAC per BWP for source PCell is higher than a 4^{th} threshold;
8) a 5^{th} number of LBT failure indications received from physical layer in the MAC per BWP for source PSCell is higher than a 5^{th} threshold;
9) a 6^{th} number of LBT failure indications received from physical layer in the MAC per BWP for target PSCell is higher than a 6^{th} threshold;
10) a RSSI of the source PCell is higher than a 7^{th} threshold
11) a RSSI of the source PSCell is higher than a 8^{th} threshold;
12) a RSSI of the target PSCell is higher than a 9^{th} threshold;
13) a channel occupancy of the source PCell is higher than a 10^{th} threshold;
14) a channel occupancy of the source PSCell is higher than a 11^{th} threshold;
15) a channel occupancy of the target PSCell is higher than a 12^{th} threshold.

In an embodiment, the successful PSCell change report includes at least one of the following:
1) one or more UL BWP IDs on the source PCell where LBT failure occurs;
2) one or more UL BWP IDs on the source PSCell where LBT failure occurs;
3) one or more UL BWP IDs on the target PSCell where LBT failure occurs;
4) a 1^{st} number of source PCell's UL BWPs where consistent LBT failure occurs;
5) a 2^{nd} number of source PSCell's UL BWPs where consistent LBT failure occurs;
6) a 3^{rd} number of target PSCell's UL BWPs where consistent LBT failure occurs
7) a 4^{th} number of LBT failure indications received from physical layer in the MAC for source PCell for each BWP;
8) a 5^{th} number of LBT failure indications received from physical layer in the MAC for source PSCell for each BWP;
9) a 6^{th} number of LBT failure indications received from physical layer in the MAC for target PSCell for each BWP;
10) a RSSI of the source PCell;
11) a RSSI of the source PSCell;
12) a RSSI of the target PSCell;
13) a channel occupancy of the source PCell;
14) a channel occupancy of the source PSCell; or
15) a channel occupancy of the target PSCell.

Still another embodiment of the present disclosure provides a method performed by a master node (MN), comprising: receiving first information related to downlink (DL) listen before talk (LBT) failure from a first secondary node (SN), and/or second information related to uplink (UL) LBT failure associated with secondary cell group (SCG) failure from one of: a user equipment (UE), or a third node, or a second SN; and determining whether or not to transfer the first information and/or the second information to the second SN for the second SN to perform a SCG failure type detection.

Still another embodiment of the present disclosure provides a method performed by a first secondary node (SN), comprising: receiving first information related to downlink (DL) listen before talk (LBT) failure, and/or second information related to uplink (UL) LBT failure associated with secondary cell group (SCG) failure; and performing a SCG failure type detection based on the first information and/or the second information.

Still another embodiment of the present disclosure provides a method performed by a first secondary node (SN), comprising: determining first information related to downlink (DL) listen before talk (LBT) failure; and transmitting the first information to a master node.

Still another embodiment of the present disclosure provides a method performed by a user equipment (UE), comprising: receiving one or more triggering conditions associated with NR-U for a successful PSCell change report; and generating a successful PSCell change report when at least one triggering condition of the one or more triggering conditions is fulfilled.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a MR-DC system with 5G core network (5GC) 100 according to some embodiments of the present disclosure.

FIG. 2 illustrates an exemplary flow chart of a SN initiated PSCell change or CPAC procedure with a LBT failure at UE side according to some embodiments of the present disclosure.

FIG. 3 illustrates an exemplary flow chart of a SN initiated PSCell change or CPAC procedure with a LBT failure at UE side according to some embodiments of the present disclosure.

FIG. 4 illustrates an exemplary flow chart of a MN initiated PSCell change or CPAC procedure with a LBT failure at UE side according to some embodiments of the present disclosure.

FIG. 5 illustrates an exemplary flow chart of a MN initiated or SN initiated PSCell change or CPAC procedure with a LBT failure at UE side according to some embodiments of the present disclosure.

FIG. 6 illustrates an exemplary flow chart of a MN initiated or SN initiated PSCell change or CPAC procedure with a LBT failure at UE side according to some embodiments of the present disclosure.

FIG. 7 illustrates an exemplary flow chart of a SN initiated PSCell change or CPAC procedure with a LBT failure at network side according to some embodiments of the present disclosure.

FIG. 8 illustrates an exemplary flow chart of a MN initiated PSCell change or CPAC procedure with a LBT failure at network side according to some embodiments of the present disclosure.

FIG. 9 illustrates a method performed by a MN for wireless communication in NR-U according to some embodiments of the present disclosure.

FIG. 10 illustrates a method performed by a SN for wireless communication in NR-U according to some embodiments of the present disclosure.

FIG. 11 illustrates a method performed by another SN for wireless communication in NR-U according to some embodiments of the present disclosure.

FIG. 12 illustrates a method performed by a UE for wireless communication in NR-U according to some embodiments of the present disclosure.

FIG. 13 illustrates a simplified block diagram of an exemplary apparatus 1300 according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a MR-DC system with 5GC 100 according to some embodiments of the present disclosure.

The MR-DC system 100 includes a UE, a master node (MN), and a secondary node (SN). The UE is configured with a master cell group (MCG), which is a group of serving cells associated with the MN, including a primary cell (PCell) and optionally one or more secondary cells (SCells). The UE is also configured with a secondary cell group (SCG), which is a group of serving cells associated with the SN, including a primary secondary cell (PSCell) and optionally one or more SCells.

The UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs include wearable devices, such as smart watches, fitness bands, optical head-mounted displays, or the like. Moreover, the UEs may be referred to as a subscriber unit, a mobile phone, a mobile station, a user, a terminal, a mobile terminal, a wireless terminal, a fixed terminal, a subscriber station, a user terminal, or any device described using other terminology used in the art. The UEs may communicate directly with the MN and the SN via uplink communication signals.

The MN and the SN may be distributed over a geographic region. In certain embodiments, the MN and the SN may also be referred to as an access point, an access terminal, a base, a macro cell, a Node-B, an enhanced Node B (eNB), a gNB, a Home Node-B, a relay node, or any device described using other terminology used in the art.

The MR-DC system 100 is compatible with any type of network that is capable of sending and receiving wireless communication signals. For example, the MR-DC system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3^{rd} generation partnership project (3GPP)-based network, a 3GPP 5G network, a satellite communications network, a high altitude platform network, and/or other communications networks.

In one embodiment, the MR-DC system 100 is compatible with the 5G NR of the 3GPP protocol, wherein the MN and the SN transmit data using an OFDM modulation scheme on the downlink and the UE transmits data on the uplink using discrete fourier transform-spread-orthogonal frequency division multiplexing (DFT-S-OFDM) or cyclic prefix-orthogonal frequency division multiplexing (CP-OFDM) scheme. More generally, the MR-DC system 100 may implement some other open or proprietary communication protocols, for example, WiMAX, among other protocols. Next generation radio access network (NG-RAN) supports a MR-DC operation. In a MR-DC scenario, a UE with multiple transceivers may be configured to utilize resources provided by two different nodes connected via non-ideal backhauls. Wherein one node may provide new radio (NR) access and the other one node may provide either evolved universal terrestrial radio access (E-UTRA) or NR access. One node may act as a master node (MN) and the other node may act as a secondary node (SN). The MN and SN are connected via a network interface (for example, an Xn interface or an X2 interface as specified in 3GPP standard documents), and at least the MN is connected to the core network.

It should be noted that the MR-DC system in the present disclosure includes any MR-DC cases, which includes NR-NR DC, EN-DC (E-UTRAN New Radio-dual connectivity), NGEN-DC (next generation EN-DC), NE-DC (NR-E-UTRA dual connectivity). This disclosure is applied for a multi-radio dual connectivity (MR-DC) scenario and/or a long term evolution (LTE)-LTE DC scenario.

During the PSCell change or CPAC procedure in the unlicensed spectrum, the UE would detach from the source PSCell and/or attempt to access to the target PSCell, before performing any transmission with the target SN, the UE and the BS (e.g. target SN for PSCell change or CPAC) should perform the LBT procedure and/or sense the unlicensed wireless channel, in order to ensure that the spectrum is not occupied by other transmissions which may be generated by non-3GPP technologies such as WiFi. The UL LBT procedure may fail at UE side, and DL LBT procedure may fail at network side. For example, the BS should sense the channel all the time, or sense the channel before data transmission via an LBT process, when the BS detects that the channel resources are occupied, unavailable, or busy, DL LBT procedure may fail at network side.

The LBT failure detection and recovery procedure specified in 3GPP documents TS38.321 are as below:

The media access control (MAC) entity may be configured by radio resource control (RRC) with a consistent LBT failure recovery procedure. Consistent LBT failure is detected per UL BWP by counting LBT failure indications, for all UL transmissions, from the lower layers to the MAC entity. For example, the UE may perform the LBT in a BWP, if the number of LBT failures in the physical layer within the valid time which represented as lbt-FailureDetectionTimer, exceeds the maximum value, which may be represented as: Ibt-FailureInstanceMaxCount, then a consistent LBT failure occurred in this BWP. When consistent LBT failure has been triggered in all UL BWPs configured with PRACH occasions on same carrier, MAC entity indicates consistent LBT failure to upper layer (e.g. RRC layer). UL LBT procedure may fail at UE side due to consistent LBT failure in MAC layer or RRC layer, i.e. UL LBT failure at UE side includes consistent LBT failure in MAC layer or RRC layer.

RRC configures the following parameters in the Ibt-FailureRecoveryConfig:
lbt-FailureInstanceMaxCount for the consistent LBT failure detection; and
lbt-FailureDetectionTimer for the consistent LBT failure detection.

The following UE variable is used for the consistent LBT failure detection procedure:
LBT_COUNTER (per serving cell): counter for LBT failure indication which is initially set to 0.

For each activated serving cell configured with lbt-FailureRecoveryConfig, the MAC entity shall perform the following steps:
1> if LBT failure indication has been received from lower layers:
   2> start or restart the lbt-FailureDetectionTimer;
   2> increment LBT_COUNTER by 1;
   2> if LBT_COUNTER>=lbt-FailureInstanceMaxCount:
      3> trigger consistent LBT failure for the active UL BWP in this Serving Cell;
      3> if this Serving Cell is the SpCell:
         4> if consistent LBT failure has been triggered in all UL BWPs configured with PRACH occasions on same carrier in this Serving Cell:
         5> indicate consistent LBT failure to upper layers
         4> else:
         5> stop any ongoing Random Access procedure in this Serving Cell;
         5> switch the active UL BWP to an UL BWP, on same carrier in this Serving Cell, configured with PRACH occasion and for which consistent LBT failure has not been triggered;
         5> initiate a Random Access Procedure.

For MN or SN initiated PSCell change or CPAC with NR-U, PSCell change, CPAC failure, or SCG failure may happen due to LBT issues (e.g. LBT failure including UL LBT failure and/or DL LBT failure) and/or radio link issues (e.g. bad radio link quality). LBT issues and/or radio link issues may occur during the PSCell change or CPAC procedure. The present disclosure generally relates to the MN initiated or SN initiated PSCell change procedure or CPAC procedure in NR-U, and how to perform failure type detection for MRO during the PSCell change or CPAC procedure.

The MN initiated or SN initiated PSCell change procedure is used to transfer a UE context from the source SN to a target SN and to change the SCG configuration in UE from the source SN to the target SN. For SCG, in MR-DC, a group of serving cells associated with the secondary node, include the SpCell (PSCell) and optionally one or more SCells.

The CPAC procedure refers to conditional PSCell addition (CPA) procedure or conditional PSCell change (CPC) procedure which is specified in 3GPP Release 16 specification and 3GPP Release 17 specification.

Specifically, the conditional PSCell addition procedure is initiated by the MN, and the MN would transmit the MN RRC reconfiguration message to the UE, which includes CPA execution condition and SN RRC reconfiguration message. Upon receiving the CPA related RRC reconfiguration message, the UE starts evaluating if the CPA execution condition is fulfilled (e.g. if the measured quality of one candidate target PSCell is better than a threshold). Upon the fulfillment of the execution condition, the UE starts accessing the corresponding target SN.

The conditional PSCell change procedure can be either initiated by the MN or the source SN. The MN sends the generated MN RRC reconfiguration message to the UE, which includes a RRC conditional reconfiguration element that consists of CPC execution condition (generated by the MN or the source SN) and SN RRC reconfiguration message (generated by the candidate target SN). Upon receiving the CPC related RRC reconfiguration message, the UE starts evaluating if the CPC execution condition is fulfilled (e.g. if the measured quality of one candidate target PSCell is offset higher than the measured quality of source PSCell). Upon the fulfillment of the CPC execution condition, the UE starts accessing the corresponding target SN.

At UE side, UL LBT failure may happen, for example, RRC layer at UE side receives a consistent LBT failure indication from MAC layer at UE side, during the RACH procedure towards the target PSCell whose channel(s) are unlicensed.

At network side, DL LBT failure may happen, for example, if the unlicensed channel(s) of target PSCell is busy, occupied, unavailable, or the energy detection/channel occupancy of the NR-U channel(s) is higher than a threshold, during the RACH procedure towards the target PSCell whose channel(s) are unlicensed, the target SN may consider the downlink (DL) LBT procedure fails, i.e. DL LBT failure.

For MN or SN initiated PSCell change or CPAC with NR-U, PSCell change or CPAC failure may happen due to radio link issues (e.g. bad radio link quality). For example, the quality of the target PSCell is bad or unstable during or after the RACH procedure towards the target PSCell whose channel(s) are unlicensed.

In order to distinguish the different failure types between radio link issues and LBT issues, the present disclosure proposes some solutions for failure type detection for MRO in different scenarios.

Furthermore, for MN initiated PSCell change or CPAC, or SN initiated PSCell change or CPAC in NR-U, the UE may successfully handover to the target PSCell. However, this successful PSCell change may be on the verge of failure, e.g. the target PSCell is not channel available or channel free enough, and the PSCell change or CPAC procedure is close to LBT failure or radio link failure (RLF). Successful PSCell change report considering unlicensed spectrum is needed, thus the network can further optimize the NR-U related configuration(s).

The drawings of the present disclosure generally includes five components, wherein UE refers to a user equipment (UE), MN refers to a MN, S-SN refers to a source SN which is a serving SN before PSCell change or CPAC is performed, and T-SN refers to a target SN which would be a serving SN after PSCell change or CPAC is successfully completed, and RN refers to a re-establishment node which is a node where the UE resumes connection after RLF or handover failure (HOF). The MN may refer to a radio access node that provides a control plane connection to the core network. In an embodiment of the present disclosure, in the E-UTRA-NR dual connectivity (EN-DC) scenario, the MN may be an eNB. In another embodiment of the present disclosure, in the LTE-LTE DC scenario, the MN may be an eNB. In still another embodiment of the present disclosure, in the next generation E-UTRA-NR Dual Connectivity (NGEN-DC) scenario, the MN may be an ng-eNB. In yet another embodiment of the present disclosure, in the NR-E-UTRA Dual Connectivity (NE-DC) scenario or the NR-NR dual connectivity (NR-DC) scenario, the MN may be a gNB. S-SN or T-SN may refer to a radio access node without a control plane connection to the core network but providing additional resources to UE. In an embodiment of the present disclosure, in the EN-DC scenario, S-SN or T-SN may be an en-gNB. In another embodiment of the present disclosure, in the LTE-LTE DC scenario, S-SN or T-SN may be an eNB. In another embodiment of the present disclosure, in the NE-DC scenario, S-SN or T-SN may be an ng-eNB. In yet another embodiment of the present disclosure, in the NR-DC scenario or the NGEN-DC scenario, S-SN or T-SN may be a gNB.

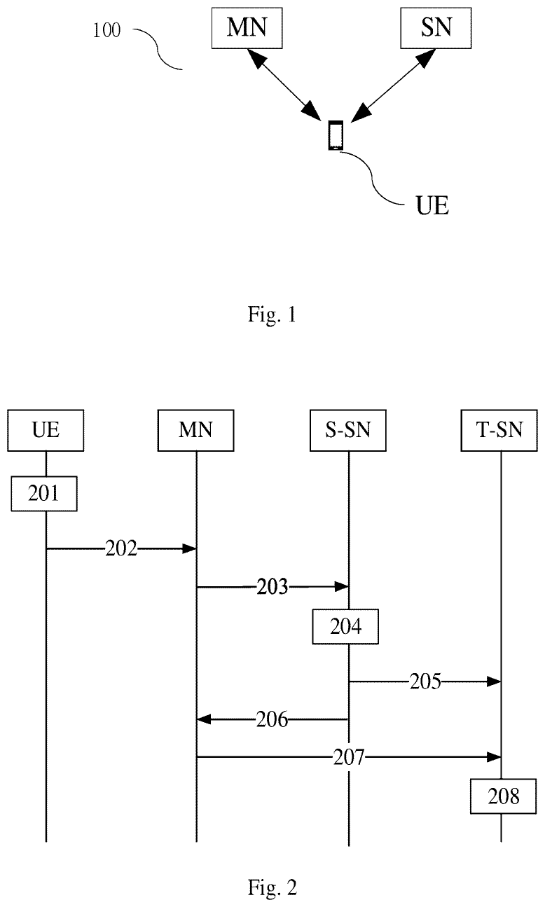

FIG. 2 illustrates an exemplary flow chart of a SN initiated PSCell change or CPAC procedure with a LBT failure at UE side according to some embodiments of the present disclosure.

In operation 201, PSCell change failure, CPAC failure, or SCG failure happens, which is caused by UL LBT failure at UE side, e.g. during the RACH procedure towards the target PSCell, when the timer T304 expires, the UE declares PSCell change failure, CPAC failure, or SCG failure.

Hereinafter in the present disclosure, if a solution is applied to any failure among the three failures, i.e. “PSCell change failure”, “CPAC failure,” or “SCG failure”, the solution can also be applied to the other failures among the three failures.

The UE may store (or log, record, generate, determine, etc.) the SCG failure related information upon or when PSCell change failure, CPAC failure, or SCG failure happens, which may include two types of information as follows:
1. the SCG failure related information associated with NR-U (which is referred to as: SCGFailureInformation-NR-U hereinafter in the present disclosure); and/or
2. the SCG failure related information not associated with NR-U, e.g. reference signal received power (RSRP), reference signal received quality (RSRQ), or signal to interference plus noise ratio (SINR) of the target PSCell, time elapsed from PSCell change or CPAC is executed to PSCell change failure, CPAC failure, or SCG failure happens.

Hereinafter in the present disclosure, the SCG failure related information associated with NR-U (i.e. SCGFailureInformation-NR-U) includes at least one of the following:
1. An indication which indicates that the PSCell change failure or the CPAC failure or SCG failure occurred due to the LBT failure. In this embodiment, the LBT failure may include at least one of the following:
   i. The LBT failure is detected in the RRC layer for the target PSCell, that is, a consistent LBT failure occurred in each of all UL BWPs on the target PSCell; or
   ii. The LBT failure is detected in the MAC layer for the target PSCell, that is, a consistent LBT failure occurred in any of the UL BWPs on the target PSCell;
2. Cause or type for the PSCell change failure, CPAC failure, or SCG failure.
   For example, the cause or type for PSCell change failure, CPAC failure, or SCG failure may be a consistent UL LBT failure on the target PSCell, alternatively, the cause or type for PSCell change failure, CPAC failure, or SCG failure may be a radio link issue, or both, etc.;
3. The UL BWP ID(s) on the target PSCell where the LBT failure occurred;
4. The number of target PSCell's UL BWPs where the consistent LBT failure occurred, or, the total number of the consistent LBT failures detected in the MAC layer for the target PSCell;
5. The number of LBT failures detected in the MAC layer for the target PSCell for each BWP, i.e. the number of LBT failure indications received from physical layer in the MAC layer for the target PSCell per BWP. That is, the number of LBT failures on different BWPs during the RACH procedure, during the UL transmission on PUSCH, during the UL transmission on PCH, and/or during semi-persistent scheduled (SPS) transmission;
6. A received signal strength indicator (RSSI) of the target PSCell. The RSSI of the target PSCell may be determined or measured at the following occasions:
   i. when the PSCell change procedure or CPAC procedure is executed;
   ii. when the LBT failure is detected by the MAC entity for target PSCell, that is, a consistent LBT failure occurred in any of the UL BWPs on the target PSCell;
   iii. when the LBT failure is detected by the RRC for target PSCell, that is, consistent LBT failure occurred in all UL BWPs on the target PSCell; or
   iv. when the PSCell change or CPAC procedure fails; or
7. A channel occupancy of the target PSCell. The channel occupancy of the target PSCell may be determined or measured at the same occasions for determining the RSSI of the target PSCell as in item 6) above.

In FIG. 2, the radio link quality of the MN is available and the LBT procedure performed by the UE with the MN is successful when the PSCell change or CPAC or SCG change fails, in operation 202, the UE sends the SCG failure related information, which may include the above SCG failure related information associated with NR-U and/or SCG failure related information not associated with NR-U, to the MN. The SCG failure related information may be transmitted via a message referred to as: SCGFailureInformation, or transmitted via a new defined message.

In operation 203, the MN sends a message including the SCG failure related information to the “analytical SN” (e.g. source SN or the last serving SN), the message may be an Xn Application protocol (XnAP) message, such as message X. The SCG failure related information may include the SCG related information associated with NR-U (i.e. SCGFailureInformation-NR-U) and/or SCG related information not associated with NR-U. In addition, the message may include an indication which indicates that NR-U related configuration(s) needs to be modified.

In operation 203, one possibility is that the MN sends the message including the SCG failure related information to the source SN that initiated the last PSCell change procedure or the last CPAC procedure. In some other cases, the PSCell change failure, CPAC failure, SCG failure may occur before the PSCell change or CPAC procedure is executed, and the solutions of the present application also apply to these cases, and the MN sends the message including the SCG failure related information to the last serving SN. Hereinafter in the present disclosure, the term “analytical SN” is used to refer to the source SN or the last serving SN, and it should be noted that the component “S-SN” in the drawings may be replaced by “analytical SN.”

In operation 204, after receiving the XnAP message X, the analytical SN performs PSCell change failure, CPAC failure, or SCG failure type detection/analysis, e.g. the analytical SN determines whether the failure is due to LBT issues (e.g. LBT failure including UL LBT failure and/or DL LBT failure) and/or due to radio link issues (e.g. bad radio link quality). In other words, the analytical SN analyzes whether the failure (e.g. PSCell change failure, CPAC failure, or SCG failure) is caused by LBT failure or not. Based on the analysis result, the analytical SN may take different actions as follows:
1. The failure (e.g. PSCell change failure, CPAC failure, or SCG failure) is due to radio link issue.
   The analytical SN decides that the cause of the failure is radio link issue. In this case, the PSCell change related configuration(s) may need to be modified, and the analytical SN may modify PSCell change related configuration(s), e.g. modify the RSRP, RSRQ, or SINR trigger threshold for PSCell change or CPAC, timer to trigger (TTT) of measurement report for PSCell change or CPAC, TTT for CPAC evaluation, etc.
2. The failure (e.g. PSCell change failure, CPAC failure, or SCG failure) is due to NR-U issue (e.g. UL LBT failure).
   The analytical SN decides that the cause of the failure is NR-U issue. In this case, the LBT/NR-U related configuration(s) may need to be modified.
   If there is a direct Xn interface between the analytical SN and the target SN, in operation 205, the analytical SN sends a message (such as an XnAP message, message K) to the T-SN directly to inform that the failure (e.g. PSCell change failure, CPAC failure, or SCG failure) occurred due to LBT failure, the message may also include an indication which indicates that NR-U/LBT related configuration(s) associated with target SCG needs to be modified or an indication (e.g. failure type) indicating that failure (e.g. PSCell change failure, CPAC failure, or SCG failure) occurred due to LBT failure.
   If there is no direct Xn interface between the analytical SN and the target SN, in operation 206, the analytical SN sends a message (such as an XnAP message, message Z) to the MN to inform the that the failure (e.g. PSCell change failure, CPAC failure, or SCG failure) occurred due to LBT failure, and/or to indicate the MN to inform the target SN that the NR-U/LBT related configuration(s) may need to be modified. That is, the message Z may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure. In operation 207, the MN sends a message (such as an XnAP message, message Y), to the target SN to inform that failure (e.g. PSCell change failure, CPAC failure, or SCG failure) occurred due to LBT failure, and/or to inform NR-U/LBT related configuration(s) associated with the target SCG needs to be modified. That is, the message Y may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure.
   It should be noted that the operation 205 and operations 206 and 207 may not exist at the same time.
   In operation 208, after receiving the XnAP message from the analytical SN, or the XnAP message Y from the MN, the target SN can modify LBT/NR-U related configuration(s) associated with the target SCG, e.g. update SCG related configuration(s) for LBT failure recovery or modify SCG related received signal strength indicator (RSSI)/channel occupancy (CO) measurement configuration(s). For example, the target SN may update the timer for consistent uplink LBT failure detection, which may be referred to as: lbt-FailureDetectionTimer, update the maximum count that determines after how many consistent uplink LBT failure events the UE triggers uplink LBT failure recovery, which may be referred to as: lbt-FailureInstanceMaxCount, etc.
3. The failure (e.g. PSCell change failure, CPAC failure, or SCG failure) is due to both radio link issue and NR-U issue (e.g. UL LBT failure).
   In this case, the analytical SN decides that the SCG failure type is radio link quality failure and LBT failure, therefore, both PSCell change related configuration and NR-U/LBT related configuration(s) associated with target SCG need to be modified, and the actions in both the above items 1 and 2 are performed.

It should be noted that the above XnAP messages, such as message X, message K, message Z and message Y, each of them includes at least one of: SCG failure related information associated with NR-U (i.e. SCGFailureInformation-NR-U), SCG failure related information not associated with NR-U, an indication which indicates that NR-U/LBT related configuration(s) needs to be modified, an indication (e.g. failure type) indicating that failure (e.g. PSCell change failure, CPAC failure, or SCG failure) occurred due to LBT failure.

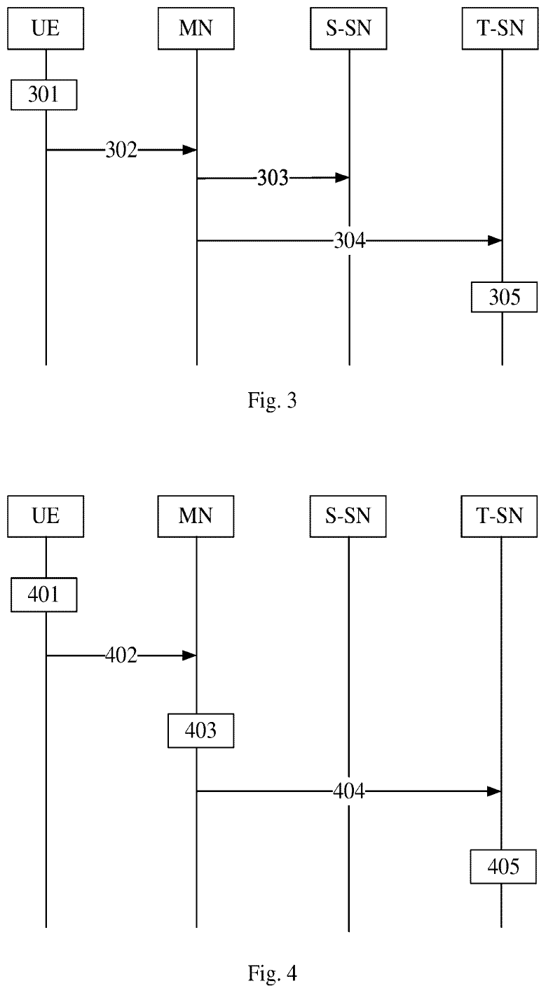

FIG. 3 illustrates an exemplary flow chart of a SN initiated PSCell change or CPAC procedure with a LBT failure at UE side according to some embodiments of the present disclosure.

Operations 301 and 302 are similar to operations 201 and 202, and the details are omitted here.

In operation 303, the MN transmits the SCG failure related information associated with NR-U (i.e. SCGFailureInformation-NR-U) and/or SCG failure related information not associated with NR-U and/or an indication which indicates that NR-U/LBT related configuration(s) needs to be modified to the analytical SN, then the analytical SN may decide the PSCell change failure, CPAC failure, or SCG failure type, or it may decide whether or how to modify PSCell change related configuration.

In operation 304, the MN sends a message, which may be an XnAP message such as message Q, to the target SN, which indicates the target SN to modify NR-U/LBT related configuration(s) associated with target SCG, for example, an indication indicating the target SN to modify NR-U/LBT related configuration(s) associated with target SCG or an indication (e.g. failure type) indicating that failure (e.g. PSCell change failure, CPAC failure, or SCG failure) occurred due to LBT failure can be included in the message Q.

In operation 305, the target SN modifies NR-U/LBT related configuration(s) associated with target SCG after receiving the message from the MN. For example, the target SN may modify RSSI/CO measurement configuration(s), and/or, the target SN may update the timer for consistent uplink LBT failure detection, which may be referred to as: lbt-FailureDetectionTimer, update the maximum count that determines after how many consistent uplink LBT failure events the UE triggers uplink LBT failure recovery, which may be referred to as: lbt-FailureInstanceMaxCount, etc.

FIG. 4 illustrates an exemplary flow chart of MN initiated PSCell change or CPAC procedure with a LBT failure at UE side according to some embodiments of the present disclosure.

Operations 401 and 402 are similar to operations 201 and 202, and the details are omitted here.

In operation 403, the MN performs failure (e.g. PSCell change failure, CPAC failure, or SCG failure) type detection/analysis, e.g. the MN determines whether the failure is due to LBT issues (e.g. LBT failure including UL LBT failure and/or DL LBT failure) and/or due to radio link issues (e.g. bad radio link quality), or, the MN decides whether to correct PSCell change related configuration, or NR-U related configuration(s), or both. Specifically, based on the analysis result, the MN may take different actions as follows:
1. The failure (e.g. PSCell change failure, CPAC failure, or SCG failure) is due to radio link issue.
   The MN decides that the cause of the failure is radio link issue. In this case, the PSCell change related configuration(s) may need to be modified, and the MN may modify PSCell change related configuration(s), e.g. modify the trigger threshold for PSCell change or CPAC, TTT of measurement report for PSCell change or CPAC, TTT for CPAC evaluation, etc.
2. The failure (e.g. PSCell change failure, CPAC failure, or SCG failure) is due to NR-U issue (e.g. UL LBT failure).
   The MN decides that the cause of the failure is NR-U issue, accordingly the NR-U/LBT related configuration(s) need to be modified.
   IN operation 404, the MN sends a message, for example, an XnAP message such as message L, to target SN to inform that failure (e.g. PSCell change failure, CPAC failure, or SCG failure) occurred due to LBT failure. The XnAP message may include at least one of: SCG failure related information associated with NR-U (i.e. SCGFailureInformation-NR-U), SCG failure related information not associated with NR-U, an indication which indicates that NR-U/LBT related configuration(s) needs to be modified, an indication (e.g. failure type) indicating that failure (e.g. PSCell change failure, CPAC failure, or SCG failure) occurred due to LBT failure.
   After receiving the message from the MN, in operation 405, the target SN may modify NR-U/LBT related configuration(s) associated with target SCG, NR-U/LBT related configuration(s) may include e.g. configuration for LBT failure recovery and/or SCG related received signal strength indicator (RSSI)/channel occupancy measurement configuration(s). For example, the target SN may update the timer for consistent uplink LBT failure detection, which may be referred to as: lbt-FailureDetectionTimer, update the maximum count that determines after how many consistent uplink LBT failure events the UE triggers uplink LBT failure recovery, which may be referred to as: lbt-FailureInstanceMaxCount, etc.
3. The failure (e.g. PSCell change failure, CPAC failure, or SCG failure) is due to both radio link issue and NR-U issue (e.g. UL LBT failure).
   The MN decides that the SCG failure type is radio link quality failure and LBT failure, therefore, both PSCell change related configuration and NR-U/LBT related configuration(s) need to be modified, and the actions in both the above items 1 and 2 are performed.

Operations 404 and 405 are similar to operations 207 and 208, and the details are omitted here.

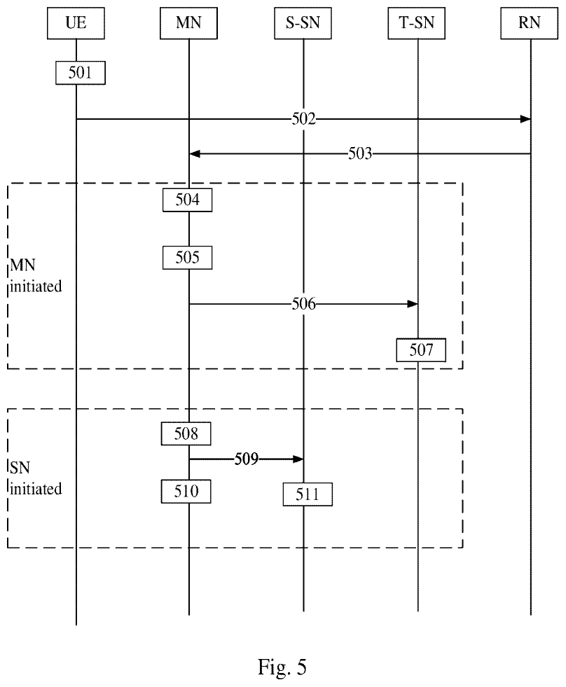

FIG. 5 illustrates an exemplary flow chart of a MN initiated or SN initiated PSCell change or CPAC procedure with a LBT failure at UE side according to some embodiments of the present disclosure.

In operation 501, PSCell change failure, CPAC failure, or SCG failure happens, which is caused by UL LBT failure at UE side, e.g. during the RACH procedure towards the target PSCell, when the timer T304 expires, the UE declares PSCell change failure, CPAC failure, or SCG failure. The UE may store (or log, record, generate, determine, etc.) the SCG failure related information upon or when PSCell change failure, CPAC failure, or SCG failure happens, which may include SCG failure related information associated with NR-U and/or SCG failure related information not associated with NR-U.

In FIG. 5, the radio link quality of the MN is not available, or LBT performed by the UE with MN fails when the PSCell change, CPAC, or SCG change fails. When MCG failure occurred, the UE also stores the MCG failure related information, which may include two types of information:
1. MCG failure related information associated with NR-U information (which is referred to as MCGFailureInformation-NR-U hereinafter in the present disclosure), and/or
2. MCG failure related information not associated with NR-U, e.g. RSRP, RSRQ, or SINR of the source PCell, time elapsed from PSCell change or CPAC is executed to PSCell change failure, CPAC failure, or SCG failure happens, time elapsed from PSCell change or CPAC is executed to MCG failure happens.

Hereinafter in the present disclosure, the MCG failure related information associated with NR-U (i.e. MCGFailureInformation-NR-U) includes at least one of the following:
1. An indication that indicates that MCG failure occurred due to LBT failure at UE side. In this embodiment, the LBT failure may include at least one of the following:
   i. LBT failure is detected in the RRC layer of the source PCell, that is, a consistent LBT failure occurred in each of all UL BWPs on the source PCell; or
   ii. LBT failure is detected in the MAC layer of the source PCell, that is, i.e. a consistent LBT failure occurred in any of the UL BWPs on the source PCell;
2. Cause or type for the MCG failure.
   For example, the cause or type for MCG failure may be a consistent UL LBT failure on the source PCell; or, the cause or type for MCG failure may be a radio link issue, or both, etc.;
3. The UL BWP ID(s) on the source PCell where LBT failure occurred at UE side;
4. The number of source PCell's UL BWPs where consistent LBT failure occurred, or, the total number of consistent LBT failures detected in the MAC for source PCell;
5. The number of LBT failures detected in the MAC for source PCell for each BWP, i.e. the number of LBT failure indications received from physical layer in the MAC for source PCell per BWP. That is, the number of LBT failures on different BWPs during RACH procedure, UL transmission on PUSCH, UL transmission on PCH, and/or during semi-persistent scheduled (SPS) transmission;
6. An RSSI of the source PCell. The RSSI of the source PCell may be determined/measured at the following occasions:
   i. when the PSCell change procedure or CPAC procedure is executed;
   ii. when the LBT failure procedure is detected by the MAC entity for the source PCell, that is, a consistent LBT failure occurred in any of the UL BWPs on the source PCell;
   iii. when the LBT failure is detected by the RRC for the source PCell, that is, consistent LBT failure occurred in all UL BWPs on the source PCell; or
   iv. when the PSCell change or CPAC procedure fails; or
7. A channel occupancy of the source PCell. The channel occupancy of the target PSCell may be determined or measured at the same occasions as determining the RSSI of the source PCell as in item 6) above.

The UE performs RRC re-establishment, and accesses to a cell managed by the re-establishment node.

In operation 502, the UE transmits a message to the re-establishment node, which may be the UE information response message, and is referred to as: UEInformationResponse, or a new defined message, in which both the SCG failure related information (e.g. including the SCG related information associated with NR-U (i.e. SCGFailureInformation-NR-U) and/or SCG related information not associated with NR-U) and the MCG failure related information (e.g. including the MCG related information associated with NR-U (i.e. MCGFailureInformation-NR-U) and/or MCG related information not associated with NR-U) are included.

In operation 503, the re-establishment node sends both the SCG failure related information and the MCG failure related information to the MN.

Operations 504-507 describes the operations for the MN initiated PSCell change or CPAC procedure with a LBT failure at UE side.

In operation 504, the MN performs failure analysis. Since the failure includes two parts, SCG failure (or PSCell change failure or CPAC failure) and MCG failure, correspondingly, the MN performs both the SCG failure type detection/analysis (operation 504a, which is a part of operation 504), e.g. the MN determines whether the SCG failure is due to LBT issues (e.g. LBT failure including UL LBT failure and/or DL LBT failure) and/or due to SCG radio link issues (e.g. bad radio link quality of SCG), and the MN performs MCG failure type detection/analysis (operation 504b, which is a part of operation 504), e.g. the MN determines whether the MCG failure is due to LBT issues (e.g. LBT failure including UL LBT failure and/or DL LBT failure) and/or due to MCG radio link issues (e.g. bad radio link quality of MCG).

In operation 504a, the MN performing the SCG failure type detection/analysis is similar to operation 403, and the details are omitted here.

In operation 504b, the MN performs the MCG failure type detection/analysis. In other words, the MN determines the cause of the MCG failure. Based on the analysis result for MCG failure, the MN may take different actions as follows:
1. The MCG failure type is due to radio link issue.
   The MN decides that the cause of the MCG failure is radio link issue. In this case, the PCell related configuration(s) may need to be modified, and the MN may modify PCell related configuration(s), e.g. modify RSRP, RSRQ, or SINR trigger threshold for PCell change, timer to trigger (TTT) of measurement report for PCell change, etc.
2. The MCG failure type is due to NR-U issue (e.g. UL LBT failure).
   The MN decides that the cause of the MCG failure is NR-U issue, accordingly the NR-U/LBT related configuration(s) associated with MCG need to be modified.
   IN operation 505, the MN modifies the NR-U/LBT related configuration(s) associated with MCG. For example, the MN may modify MCG related RSSI/CO measurement configuration(s), or update MCG related configuration(s) for LBT failure recovery, including updating the timer for consistent uplink LBT failure detection, which may be referred to as: lbt-FailureDetectionTimer, updating the maximum count that determines after how many consistent uplink LBT failure events the UE triggers uplink LBT failure recovery, which may be referred to as: lbt-FailureInstanceMaxCount, etc.
3. The MCG failure type is due to both radio link issue and NR-U issue.
   The MN decides that the MCG failure type is radio link quality failure and LBT failure, therefore, both MCG configuration (e.g. PCell related configuration(s)) and NR-U/LBT related configuration(s) associated with MCG need to be modified, and the actions in both the above items 1 and 2 are performed.

Operations 506 and 507 are similar to operations 207 and 208, and the details are omitted here.

Operations 508-511 describes the operations for the SN initiated PSCell change or CPAC procedure with a LBT failure at UE side.

Operation 508 is similar to operation 504b, i.e. the MN performs the MCG failure type detection/analysis. If the MN decides MCG failure type is due to NR-U issue (e.g. UL LBT failure), the MN performs operation 510, which is similar to operation 505, i.e. the MN modifies the NR-U/LBT related configuration(s) associated with MCG, and the details are omitted here.

Optionally, after operation 510, the MN may send a message, to target SN to inform that failure (e.g. PSCell change failure, CPAC failure, or SCG failure) occurred due to LBT failure or NR-U/LBT related configuration(s) associated with target SCG needs to be modified. That is, the message sent from the MN to the target SN may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure. Then the target SN may modify NR-U/LBT related configuration(s) associated with target SCG, NR-U/LBT related configuration(s) may include, e.g. configuration for LBT failure recovery and/or SCG related RSSI/CO measurement configuration(s). That is, the operations similar to operation 304 and operation 305 in FIG. 3 are performed.

After receiving both the SCG failure related information and the MCG failure related information from the re-establishment node in operation 503, in operation 509, the MN transmits the SCG failure related information, which may include SCG failure related information associated with NR-U information, and/or SCG failure related information not associated with NR-U to analytical SN (e.g. source SN or the last serving SN). In operation 511, the analytical SN performs PSCell change failure, CPAC failure, or SCG failure type detection/analysis based on the SCG failure related information, in a similar way as operation 204 in FIG. 2.

After deciding that the cause of the failure is NR-U issue, the analytical SN may send a message to the T-SN directly, or transmit the message to the MN, and the MN transmit the message to inform that the failure (e.g. PSCell change failure, CPAC failure, or SCG failure) occurred due to LBT failure, that is, the message may include an indication which indicates that NR-U/LBT related configuration(s) associated with target SCG needs to be modified or an indication (e.g. failure type) indicating that failure (e.g. PSCell change failure, CPAC failure, or SCG failure) occurred due to LBT failure. That is, the operations similar to operations 205-208 in FIG. 2 are performed.

In some cases, the T-SN may receive messages from both the MN and the analytical SN, both messages informing that the failure (e.g. PSCell change failure, CPAC failure, or SCG failure) occurred due to LBT failure, an indication which indicates that NR-U/LBT related configuration(s) associated with target SCG needs to be modified or an indication (e.g. failure type) indicating that failure (e.g. PSCell change failure, CPAC failure, or SCG failure) occurred due to LBT failure may be included in the message. That is, both operation 205 (or 207) in FIG. 2 and operation 304 in FIG. 3 occur, and the T-SN can modify the NR-U/LBT related configuration(s) associated with target SCG based on both messages.

It should be noted that operations 508-511 depicted in FIG. 5 seem to have specific orders, however, operation 508 may be performed simultaneously or any order with operation 509 or operation 511, or operation 509 may be performed simultaneously or any order with operation 509 or operation 511.

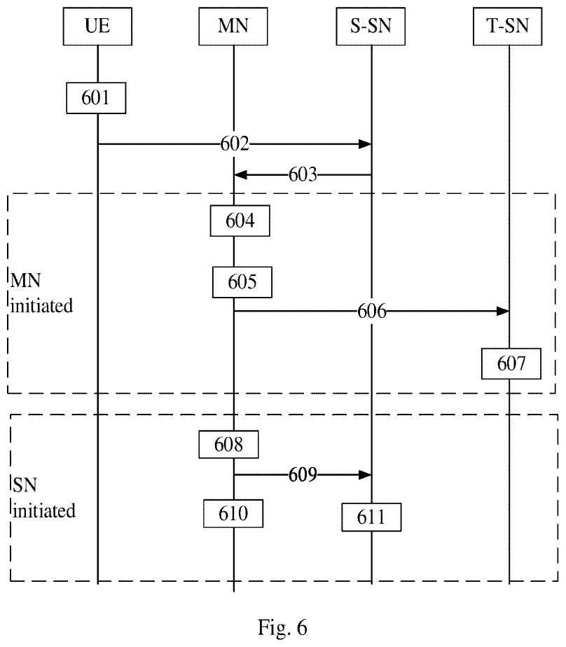

FIG. 6 illustrates an exemplary flow chart of a MN or SN initiated PSCell change or CPAC procedure with a LBT failure at UE side according to some embodiments of the present disclosure.

In operation 601, the PSCell change failure, CPAC failure, or SCG failure happens, which is caused by UL LBT failure at UE side, e.g. during the RACH procedure towards the target PSCell, when the timer T304 expires, the UE declares PSCell change failure, CPAC failure, or SCG failure. The UE may store (or log, record, generate, determine, etc.) the SCG failure related information upon or when PSCell change failure, CPAC failure, or SCG failure happens, which may include SCG failure related information associated with NR-U and/or SCG failure related information not associated with NR-U.

In FIG. 6, the radio link quality of the MN is not available or LBT performed by the UE with MN fails when the PSCell change or CPAC fails. When MCG failure occurred, the UE also stores the MCG failure related information, which may include MCG failure related information associated with NR-U information, and/or MCG failure related information not associated with NR-U (e.g. RSRP/RSRQ/SINR of the source PCell, time elapsed from PSCell change or CPAC is executed to PSCell change failure, CPAC failure, or SCG failure happens, time elapsed from PSCell change or CPAC is executed to MCG failure happens).

In this case, if radio link quality of the S-SN is available and LBT performed by the UE at UE side with S-SN succeeds, when both SCG failure and MCG failure happens, or when only SCG failure happens, or only MCG failure happens, the UE can recover the link with S-SN or fallback to the S-SN. In operation 602, when both SCG failure and MCG failure happen, the UE transmits the SCG failure related information and MCG failure related information to S-SN, i.e. the UE sends both the SCG failure related information (e.g. including the SCG related information associated with NR-U (i.e. SCGFailureInformation-NR-U) and/or SCG related information not associated with NR-U), and the MCG failure related information (e.g. including the MCG related information associated with NR-U (i.e. MCGFailureInformation-NR-U) and/or MCG related information not associated with NR-U) to the S-SN. When only SCG failure happens, in operation 602, the UE transmits the SCG failure related information to S-SN. When only MCG failure happens, in operation 602, the UE transmits the MCG failure related information to S-SN.

In operation 603, S-SN sends the SCG failure related information if any and MCG failure related information if any to the MN.

Operations 604-607 describe the operations for the MN initiated PSCell change or CPAC procedure with a LBT failure at UE side.

The MN then performs the failure analysis, i.e. the MN performs the SCG failure type detection/analysis based on SCG failure related information if any (similar to operation 504a in FIG. 5), and/or, the MN performs MCG failure type detection/analysis based on MCG failure related information if any (similar to operation 504b in FIG. 5). Operations 604, 605, 606 and 607 are similar to operations 504, 505, 506, and 507, and the details are omitted here.

Operations 608-611 describes the operations for the SN initiated PSCell change or CPAC procedure with a LBT failure at UE side. These operations are similar to operations 508-511, and the details are omitted here.

In FIGS. 2-6, the LBT failure at UE side is illustrated; on the other hand, the LBT failure may also occur at the network side. Specifically, when the target SN detects the unlicensed channel(s) of the target PSCell/SN are busy, the channel(s) are occupied, the channel(s) resources are unavailable, the energy detection/channel occupancy is above a threshold, etc., the target SN determines DL LBT failure, i.e. the LBT procedure fails at the target PSCell.

For MN or SN initiated PSCell change or CPAC, if PSCell change/CPAC failure is caused by LBT failure at network side, e.g. the target SN detects that the unlicensed channel(s) of target PSCell is busy/occupied/unavailable during RACH, when the timer T304 expires, the UE would declare PSCell change/CPAC/SCG failure, and the UE can store and send SCG failure related information not associated with NR-U (e.g. RSRP/RSRQ/SINR of the target PSCell, time elapsed from PSCell change or CPAC is executed to PSCell change failure, CPAC failure, or SCG failure happens) to the network.

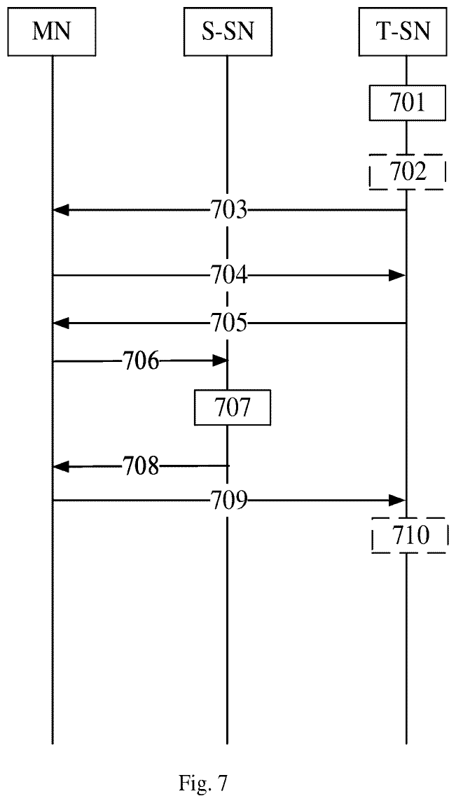

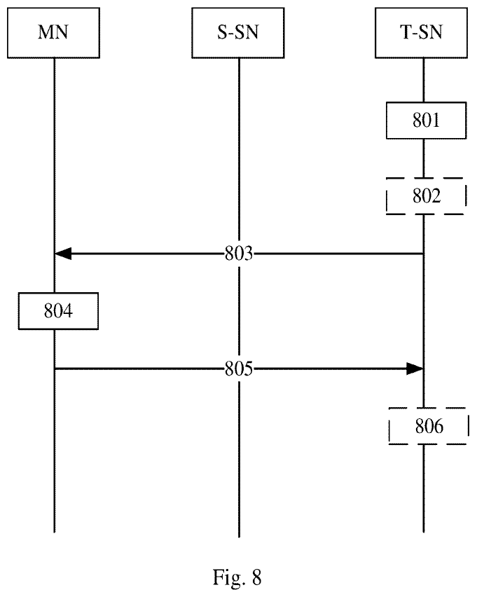

Case A: the radio link quality of the MN is available and LBT performed by the UE with the MN is successful when the PSCell change or CPAC procedure or SCG change fails, the UE can send SCG failure related information not associated with NR-U to the MN via the message referred to as: SCGFailureInformation. In Case A, when it is MN initiated PSCell change or CPAC procedure, it is the MN that performs SCG failure type detection/analysis and subsequent operations (see details in FIG. 8). In case A, when it is SN initiated PSCell change or CPAC procedure, MN would send SCG failure related information to the source SN or the last serving SN, then the source SN or the last serving SN performs SCG failure type detection/analysis and subsequent operations (see details in FIG. 7).

Case B: radio link quality of the MN is not available or LBT performed by the UE with the MN fails when the PSCell change or CPAC procedure or SCG change fails, the UE would perform the RRC re-establishment procedure. After accessing to the re-established cell, the UE may send SCG failure related information not associated with NR-U, and MCG failure related information (including MCG failure related information associated with NR-U and/or MCG failure related information not associated with NR-U) to the re-establishment node, e.g. via UEInformationResponse message or a new defined message. Then, the re-establishment node would send SCG failure related information not associated with NR-U and MCG failure related information to the MN. In case B, when it is MN initiated PSCell change or CPAC procedure, it is the MN that performs SCG failure type detection/analysis (see details in FIG. 8) and MCG failure type detection/analysis (similar to operation 504b). In case B, when it is SN initiated PSCell change or CPAC procedure, it is MN that performs the MCG failure type detection/analysis (similar to operation 504b), and MN would send SCG failure related information to the source SN or the last serving SN, then the source SN or the last serving SN performs SCG failure type detection/analysis (see details in FIG. 7).

In Case B, the re-establishment node can send SCG failure related information not associated with NR-U, and the MCG failure related information (including MCG failure related information associated with NR-U and/or MCG failure related information not associated with NR-U) to the MN, the MN can modify NR-U/LBT related configuration(s) associated with MCG based on MCG failure related information associated with NR-U if any when it decides that MCG failure is due to LBT failure in MN. For example, the MN may modify MCG related RSSI/CO measurement configuration(s), and/or update MCG related configuration for LBT failure recovery, including updating the timer for consistent uplink LBT failure detection, which may be referred to as: lbt-FailureDetectionTimer, updating the maximum count that determines after how many consistent uplink LBT failure events the UE triggers uplink LBT failure recovery, which may be referred to as: lbt-FailureInstanceMaxCount, etc.

Case C: the radio link quality of the MN is not available or LBT performed by the UE with the MN fails, for example when the PSCell change or CPAC procedure or SCG change fails due to bad radio link quality, the radio link quality of the S-SN is available and LBT performed by the UE at UE side with S-SN succeeds, when both SCG failure and MCG failure happens, or when only PSCell change or CPAC failure happens, or only MCG failure happens, the UE can recover the link with S-SN or fallback to the S-SN.

After recovering the link with S-SN or fallback to the S-SN, the UE may send SCG failure related information not associated with NR-U, and/or MCG failure related information (including MCG failure related information associated with NR-U and/or MCG failure related information not associated with NR-U) to the S-SN. In case C, when it is MN initiated PSCell change or CPAC procedure, the S-SN would send SCG failure related information not associated with NR-U if any and MCG failure related information if any to the MN, it is the MN performs SCG failure type detection/analysis (see details in FIG. 8) and MCG failure type detection/analysis (similar to operation 504b). In case C, when it is SN initiated PSCell change or CPAC procedure, the S-SN would send MCG failure related information if any to the MN, it is the MN that performs the MCG failure type detection/analysis (similar to operation 504b), and the source SN or the last serving SN performs SCG failure type detection/analysis (see details in FIG. 7).

For the above cases, the MCG failure related information associated with NR-U is MCGFailureInformation-NR-U.

For MN or SN initiated PSCell change or CPAC, if the PSCell change failure, CPAC failure, or SCG failure is caused by LBT failure at network side, e.g. target SN detects channel of target PSCell is occupied/unavailable/busy, e.g. during the RACH procedure, the target SN may take different options as follows:

### Option 1

Upon the target SN detects LBT failure in the target PSCell, a class 2 procedure is performed, i.e. the target SN sends information associated with DL LBT failure or information associated with NR-U (e.g. via message A) to the MN, e.g. to inform the MN that PSCell change failure, CPAC failure (or RACH failure), or SCG failure occurred due to LBT failure in the target PSCell or due to target channel is occupied/busy/unavailable. Optionally, the target SN can modify NR-U/LBT related configuration(s) associated with target SCG upon the target SN detects that LBT failure in target PSCell, and optionally the target SN can inform the MN that target SN has modified NR-U/LBT related configuration(s).

### Option 2

Upon the target SN detects LBT failure in target PSCell, the target SN can optionally modify NR-U/LBT related configuration(s) associated with SCG, and optionally the target SN can inform the MN that target SN has modified NR-U/LBT related configuration(s). Also, target SN can send a message, for example, an XnAP message such as message W, to the MN to ask whether it is a MN initiated PSCell change/CPAC procedure or a SN initiated PSCell change/CPAC procedure, then the MN responds to target SN based on target SN's ask, for example, the MN can respond to target SN that it is a MN initiated PSCell change/CPAC procedure, or, the MN can respond to target SN that it is a SN initiated PSCell change/CPAC procedure.
After receiving the MN's response, if it is a SN initiated PSCell change or CPAC procedure, the target SN sends information associated with DL LBT failure or information associated with NR-U (e.g. via an XnAP message such as message A) to the MN, e.g. to inform the MN that PSCell change or CPAC failure (or RACH failure) or SCG failure occurred due to LBT failure in target PSCell; if it is a MN initiated PSCell change or CPAC procedure, target SN modifies NR-U/LBT related configuration(s) associated with target SCG, after the target SN modifies NR-U/LBT related configuration(s) associated with target SCG, the target SN informs the MN that target SN has modified NR-U/LBT related configuration(s), the target SN may not need to send information associated with DL LBT failure or information associated with NR-U to the MN, and the MN decides whether or how to correct PSCell change related configuration(s).

The XnAP message A may be an existing XnAP message or a new introduced XnAP message to include information associated with DL LBT failure or information associated with NR-U. At least one of the following can be included in the XnAP message A as the information associated with DL LBT failure or information associated with NR-U:
1. An indication to indicate that PSCell change failure, CPAC failure, or SCG failure occurred due to the LBT failure at target SN, or due to NR-U channel(s) in target PSCell are busy, occupied, or unavailable;
2. A PSCell change or CPAC failure cause or type, e.g. NR-U channel(s) are busy, occupied, or unavailable in the target SN;
3. An indication to indicate that NR-U/LBT related configuration(s) associated with target SCG needs to be modified;
4. Information for NR-U channel(s) which are busy, occupied, or unavailable, e.g. BWP ID, channel ID, absolute radio frequency channel number (ARFCN), bandwidth, etc.;
5. Information for LBT events in target PSCell, e.g. a number of unsuccessful LBT events, LBT backoff time, LBT sensing duration, channel free time percentage, channel busy time percentage, channel occupied time percentage, channel unavailable time percentage, etc.;
6. A RSSI of the target PSCell when DL LBT fails or when the NR-U channel(s) in target PSCell are busy, occupied, or unavailable; or
7. A channel occupancy of the target PSCell when DL LBT fails or when the NR-U channel(s) in target PSCell are busy, occupied, or unavailable.

FIG. 7 illustrates an exemplary flow chart of a SN initiated PSCell change or CPAC procedure with a LBT failure at network side according to some embodiments of the present disclosure.

In operation 701, the target SN detects LBT failure at network side. Specifically, the target SN determines that the channel of target PSCell is busy, occupied, or unavailable. For example, when the channel occupancy or energy detection of the target PSCell is above a threshold, the target SN determines LBT failure at network side.

Optionally, in operation 702, the target SN modifies NR-U/LBT related configuration(s) associated with target SCG.

When the target SN take the above mentioned option 1, after operation 701 or 702, a class 2 procedure is performed, i.e. the target SN sends information associated with DL LBT failure or information associated with NR-U (e.g. via message A) to the MN, e.g. to inform the MN that PSCell change failure, CPAC failure (or RACH failure), or SCG failure occurred due to LBT failure in the target PSCell or due to target channel is occupied/busy/unavailable. Optionally, the target SN can modify NR-U/LBT related configuration(s) associated with target SCG upon the target SN detects that LBT failure in target PSCell, and optionally the target SN can inform the MN that target SN has modified NR-U/LBT related configuration(s), i.e. an indication indicating that the target SN has already modified the NR-U/LBT related configuration(s) associated with target SCG may be included in message A or in a new message.

When the target SN take the above mentioned option 2, after operation 701 or 702, the following operations are performed:

In operation 703, the target SN send a message, for example, an XnAP message such as message W to the MN to ask whether it is a MN initiated PSCell change/CPAC procedure, or a SN initiated PSCell change/CPAC procedure.

In operation 704, the MN responds to the T-SN it is MN initiated PSCell change/CPAC procedure, or it is the SN initiated PSCell change/CPAC procedure.

If in operation 704, the MN responds that it is the SN initiated PSCell change/CPAC procedure, in operation 705, the target SN transmits a message to the MN, which may be an XnAP message such as message A, or a new message, wherein the information associated with DL LBT failure or information associated with NR-U as mentioned above (preceding the description of FIG. 7) is included. If in operation 704, the MN responds to T-SN that it is the MN initiated PSCell change/CPAC procedure, then T-SN would modify NR-U/LBTrelated configuration(s) associated with target SCG after getting response via operation 704, and the target SN may transmit an indication to the MN to indicate that the target SN has already modified the NR-U/LBT related configuration(s) associated with target SCG. The indication may be sent in operation 705 via a XnAP message. In other scenarios, the target SN may has modified NR-U/LBT related configuration(s) associated with target SCG in operation 702 or after getting response via operation 704, but does not transmit the indication to indicate the MN that the target SN has already modified the NR-U/LBT related configuration(s) associated with target SCG.

In operation 706, since it is SN initiated PSCell change or CPAC, the MN transmits a message to analytical SN (i.e. S-SN or the last serving SN), which may be an XnAP message such as message B, or a new message, wherein the information associated with DL LBT failure or information associated with NR-U is included. The XnAP message (i.e. message B) may include similar parameters as message A. For above Case A or Case B, MN would also transmit SCG failure related information not associated with NR-U received from the UE or the re-establishment node to the analytical SN via message B or a new message.

In operation 707, the analytical SN (i.e. S-SN or the last serving SN) performs failure (e.g. PSCell change failure, CPAC failure, or SCG failure) detection/analysis, e.g. the analytical SN determines whether the failure is due to LBT issues (e.g. LBT failure including UL LBT failure and/or DL LBT failure) and/or due to radio link issues (e.g. bad radio link quality), or, decides whether PSCell change related configuration and/or NR-U/LBT related configuration(s) need to be optimized.

Based on the analysis result, the analytical SN may take different actions as follows:
1. The failure (e.g. PSCell change failure, CPAC failure, or SCG failure) is due to radio link issue.
   The analytical SN decides that the cause of the failure is the radio link issue. In this case, PSCell change related configuration needs to be modified, the analytical SN modifies PSCell change related configuration, e.g. RSRP/RSRQ/SINR trigger threshold for PSCell change/CPAC, TTT of measurement report for PSCell change/CPAC, TTT for CPAC evaluation.
2. The failure (e.g. PSCell change failure, CPAC failure, or SCG failure) is due to NR-U issue (e.g. DL LBT failure).
   In the case that the target SN has modified the NR-U/LBT related configuration(s) (e.g. in operation 702), and also has informed the MN that target SN has modified the same in message A or a new message (e.g. in operation 703 or operation 705), in operation 706, the MN can inform the analytical SN that target SN has modified NR-U/LBT related configuration(s) associated with target SCG in message B or in a new message. For example, an indication indicating that target SN has modified NR-U/LBT related configuration(s) may be included in the message B or a new message.
   Otherwise, if the target SN has not modified the NR-U/LBT related configuration(s), or the target SN has modified the NR-U/LBT related configuration(s) but did not inform the MN, neither the MN nor the analytical SN knows that target SN has modified the NR-U/LBT related configuration(s), in the case, the MN and the analytical SN consider that the NR-U related configurations are not modified.
   In operation 707, the analytical SN performs the failure (e.g. PSCell change failure, CPAC failure, or SCG failure) type detection/analysis. That is, the analytical SN determines whether the failure is due to LBT issues (e.g. LBT failure including UL LBT failure and/or DL LBT failure) and/or due to radio link issues (e.g. bad radio link quality), or, decides whether PSCell change related configuration and/or NR-U/LBT related configuration(s) need to be optimized. If it decides that failure is due to DL LBT issues or NR-U/LBT related configuration(s) needs to be optimized, in operation 708, the analytical SN sends a message, for example, an XnAP message such as message Z, to the MN to inform that PSCell change/CPAC/SCG failure occurred due to LBT failure or NR-U/LBT related configuration(s) needs to be modified, that is the message Z may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure.
   After receiving message Z, optionally, in operation 709, the MN sends one XnAP message (e.g. message P) to target SN to inform that PSCell change/CPAC/SCG failure occurred due to DL LBT failure or NR-U/LBT related configuration(s) needs to be modified, that is the message P may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure.
   In operation 710, after receiving the XnAP message P from the MN, the target SN can modify NR-U/LBT related configuration(s) associated with target SCG if not performed already, e.g. update SCG related configuration for LBT Failure Recovery (e.g. including: lbt-FailureDetectionTimer which is a timer for consistent uplink LBT failure detection, lbt-FailureInstanceMaxCount that determines after how many consistent uplink LBT failure events the UE triggers uplink LBT failure recovery) and/or modify RSSI/CO measurement configuration for target SCG). The XnAP messages, message B, Z or P, may include similar parameters as message A.
3. The failure (e.g. PSCell change failure, CPAC failure, or SCG failure) is due to both radio link issue and the NR-U issue (e.g. DL LBT failure) both.
   In this case, the analytical SN decides that the SCG failure type is radio link issue and DL LBT failure issue both, therefore, both PSCell change related configuration and NR-U/LBT related configuration(s) associated with target SCG need to be modified, and the actions in both the above items 1 and 2 are performed.

FIG. 8 illustrates an exemplary flow chart of a MN initiated PSCell change or CPAC procedure with a LBT failure at network side according to some embodiments of the present disclosure.

Operation 801-802 are similar to operations 701-702 respectively, and the details are omitted here.

When the target SN take the above mentioned option 1, in operation 803, the target SN sends a message indicating the information associated with DL LBT failure/information associated with NR-U to the MN, to inform the MN that PSCell change/CPAC failure (or RACH failure)/SCG failure occurs due to DL LBT failure in the target PSCell. After receives the message indicating the information associated with DL LBT failure from the target SN, and the SCG failure related information (e.g. SCG failure related information not associated with NR-U) from the UE (in above Case A) or the S-SN (in above Case C) or the re-establishment node (in above Case B), in operation 804, the MN performs failure analysis. In other words, the MN performs failure (e.g. PSCell change failure, CPAC failure, or SCG failure) detection/analysis, e.g. the MN determines whether the failure is due to LBT issues (e.g. LBT failure including UL LBT failure and/or DL LBT failure) and/or due to radio link issues (e.g. bad radio link quality), or, the MN decides whether PSCell change related configuration and/or NR-U/LBT related configuration(s) need to be optimized:
1. The failure (e.g. PSCell change failure, CPAC failure, or SCG failure) is due to radio link issue.
   The MN decides that the cause of the PSCell change/CPAC/SCG failure is the radio link issue. In this case, the PSCell change related configuration(s) may need to be modified, and the MN may modify PSCell change related configuration(s), e.g. the RSRP, RSRQ, or SINR trigger threshold for PSCell change or CPAC, TTT of measurement report for PSCell change or CPAC, TTT for CPAC evaluation, etc.
2. The failure (e.g. PSCell change failure, CPAC failure, or SCG failure) is due to is the NR-U issue (e.g. DL LBT failure).
   The MN decides that the cause of the PSCell change/CPAC/SCG failure is the NR-U issue (e.g. DL LBT failure). In this case, based on whether the target SN has informed MN that target SN has modified NR-U/LBT related configuration(s), the MN may take different operations as follows:
   i. If the target SN has informed the MN that target SN has modified NR-U/LBT related configuration(s) in the message, such as an XnAP message, message A or a new message (e.g. in operation 703 or operation 705), the MN does not need to inform the target SN that NR-U/LBT related configuration(s) associated with target SCG needs to be modified;
   ii. Otherwise, if the target SN did not inform the MN that the target SN has modified NR-U/LBT related configuration(s), and the MN (or analytical SN) does not know whether the target SN has modified NR-U/LBT related configuration(s), when the MN decides that PSCell change/CPAC/SCG failure is due to the NR-U issue (e.g. DL LBT failure), or NR-U/LBT related configuration(s) associated with target SCG needs to be modified, in operation 805, the MN sends a message, for example, an XnAP message such as message M, to target SN to inform that PSCell change/CPAC/SCG failure due to LBT failure or NR-U related configuration(s) associated with target SCG needs to be modified. The message M may include similar parameters as message A. Also, the message M may include an indication which indicates that NR-U/LBT related configuration(s) associated with target SCG needs to be modified, or an indication (e.g. failure type) indicating that failure (e.g. PSCell change failure, CPAC failure, or SCG failure) occurred due to LBT failure.
   In operation 806, after receiving the XnAP message M from the MN, the target SN can modify NR-U/LBT related configuration(s) associated with target SCG in a similar way as in operation 710.
3. The failure (e.g. PSCell change failure, CPAC failure, or SCG failure) is due to both radio link issue and the NR-U issue (e.g. DL LBT failure).
   The MN decides that the cause of the PSCell change/CPAC/SCG failure is both radio link issue and the NR-U issue (e.g. DL LBT failure). Therefore, both PSCell change related configuration and NR-U/LBT related configuration(s) need to be modified, and the actions in both the above items 1 and 2 are performed.

When the target SN take the above mentioned option 2 (that is: the target SN gets response from MN that it is a MN initiated PSCell change/CPAC, target SN modifies NR-U related configuration(s) associated with target SCG after it detects DL LBT failure, and target SN informs MN that target SN has modified NR-U related configuration(s) associated with target SCG), after receives the SCG failure related information (e.g. SCG failure related information not associated with NR-U) from the UE (in above Case A) or the re-establishment node (in above Case B) or the S-SN (in above Case C), the MN performs MRO analysis based on SCG failure related information, e.g. MN decides whether or how to correct PSCell change related configuration.

In view of the above:
FIGS. 2 and 3 relates to a SN initiated PSCell change or CPAC procedure with a LBT failure at UE side.
FIG. 4 relates to a MN initiated PSCell change or CPAC procedure with a LBT failure at UE side.
FIG. 5 relates to a MN initiated or SN initiated PSCell change or CPAC procedure with a LBT failure at UE side.
FIG. 6 relates to a MN initiated or SN initiated PSCell change or CPAC procedure with a LBT failure at UE side.
FIG. 7 relates to a SN initiated PSCell change or CPAC procedure with a LBT failure at network side.
FIG. 8 relates to a MN initiated PSCell change or CPAC procedure with a LBT failure at network side.

It should be noted that the LBT failure may fail at both UE side and the network side. That is, some of the above solutions described in the drawings may occur at the same time. For example, the solutions in any one of FIGS. 2, 3, 5 and 6 (only solutions with the SN initiated PSCell change or CPAC procedure with a LBT failure at UE side in FIGS. 5 and 6) may be combined with the solutions in FIG. 7. The solutions in any one of FIGS. 4, 5, and 6 (only solutions with the MN initiated PSCell change or CPAC procedure with a LBT failure at UE side in FIGS. 5 and 6) may be combined with the solutions in FIG. 8.

It should be also noted in FIGS. 2-8, the messages are transmitted via the interfaces among the different networks nodes, in some cases, there is no interface among these networks nodes (e.g. in inter-system PSCell change or CPAC procedure, or in inter-radio access technology (RAT) PSCell change or CPAC procedure), these messages may be transmitted via core network (e.g. evolved packet core (EPC) or 5G core network (5GC)). For example, in operation 709, the MN can send one S1/NG message to EPC/5GC to inform that PSCell change/CPAC/SCG failure occurred due to DL LBT failure or NR-U/LBT related configuration(s) needs to be modified, then EPC/5GC can send one S1/NG message to the target SN to inform that PSCell change/CPAC/SCG failure occurred due to DL LBT failure or NR-U/LBT related configuration(s) needs to be modified.

In NR-U, the successful PSCell change report may be introduced, e.g. for MN or SN initiated normal PSCell change, or, for MN or SN initiated CPAC. Based on successful PSCell change report, the network can make decision for NR-U related configuration(s) optimization. For example, the network may select proper LBT modes or parameters or resources, or adjust resource configurations to increase LBT success rate thus to minimize RLF or PSCell change/CPAC/SCG failure cases.

The present disclosure proposes that some triggering conditions associated with NR-U for a successful PSCell change report may be configured, and the UE may generate (log, determine, or store) a successful PSCell change report when at least one triggering condition of the one or more triggering conditions is fulfilled. Then the successful PSCell change report is transmitted to the network, to improve the MRO for PSCell change or CPAC in NR-U.

At least one of the following can be configured as the triggering condition for generating a successful PSCell change report, considering unlicensed spectrum in the source SpCell (i.e. SpCell includes PCell in MCG or PSCell in SCG) and/or the target SpCell:
1. LBT failure (e.g. LBT failure is detected in the physical (PHY) layer for the source PCell, or consistent LBT failure is detected in the MAC layer for the source PCell) occurred in at least one UL BWP on the source PCell, this triggering condition can be configured by the MN;
2. LBT failure (e.g. LBT failure is detected in the PHY layer for the source PSCell, or consistent LBT failure is detected in the MAC layer for the source PSCell) occurred in at least one UL BWP on the source PSCell, this triggering condition can be configured by the source SN or the MN;
3. LBT failure (e.g. LBT failure is detected in the PHY layer of the target PSCell, or consistent LBT failure is detected in the MAC layer for the target PSCell) occurred in at least one UL BWP on the target PSCell, this triggering condition can be configured by the target SN or the MN;
4. The number of source PCell's UL BWPs where consistent LBT failure occurred is higher than a configured threshold, or, the number of consistent LBT failures detected in the MAC for the source PCell is higher than a configured threshold. This triggering condition can be configured by the MN, the threshold can be an absolute value or percentage value;
5. The number of source PSCell's UL BWPs where consistent LBT failure occurred is higher than a configured threshold, or, the number of consistent LBT failures detected in the MAC for the source PSCell is higher than a configured threshold. This triggering condition can be configured by the source SN or MN, the threshold can be an absolute value or percentage value;
6. The number of target PSCell's UL BWPs where consistent LBT failure occurred is higher than a configured threshold, or, the number of consistent LBT failures detected in the MAC for the target PSCell is higher than a configured threshold. This triggering condition can be configured by the target SN or the MN, the threshold can be an absolute value or percentage value;
7. The per BWP number of LBT failure indications received from physical layer in the MAC for the source PCell is higher than a configured threshold. This triggering condition can be configured by the MN, the threshold can be an absolute value or percentage value;
8. The per BWP number of LBT failure indications received from physical layer in the MAC for the source PSCell is higher than a configured threshold. This triggering condition can be configured by the source SN or the MN, the threshold can be an absolute value or percentage value;
9. The per BWP number of LBT failure indications received from physical layer in the MAC per BWP for the target PSCell is higher than a configured threshold. This triggering condition which can be configured by the target SN or the MN, the threshold can be an absolute value or percentage value;
10. A RSSI of the source PCell is higher than a configured threshold, which can be configured by the MN. The threshold can be an absolute value or percentage value configured by the MN;
11. A RSSI of the source PSCell is higher than a configured threshold, which can be configured by the source SN or the MN. The threshold can be an absolute value or percentage value configured by the source SN or the MN;
12. A RSSI of the target PSCell is higher than a configured threshold, which can be configured by the target SN or MN or source SN. The threshold can be an absolute value or percentage value configured by the target SN or the MN or source SN;
13. A channel occupancy of the source PCell is higher than a configured threshold, which can be configured by the MN. The threshold can be an absolute value or percentage value configured by the MN;
14. A channel occupancy of the source PSCell is higher than a configured threshold, which can be configured by the source SN or the MN. The threshold can be an absolute value or percentage value configured by the source SN or the MN; or
15. A channel occupancy of the target PSCell is higher than a configured threshold, which can be configured by the source SN, the target SN or the MN. The threshold can be an absolute value or percentage value configured by the source SN, the target SN or the MN.

The above triggering conditions can be configured in the RRC reconfiguration message that for PSCell change or CPAC to the UE. When at least one triggering condition is fulfilled, the UE would store/record/generate related information for successful PSCell change report. If no triggering condition is configured, or none of triggering condition is fulfilled, the UE would not store/record/generate related information for successful PSCell change report.

The detailed contents in the successful PSCell change report may include at least one of the following:
1. One or more UL BWP IDs on the source PCell where LBT failure (e.g. LBT failure is detected in the PHY layer for source PCell, or consistent LBT failure is detected in the MAC layer for source PCell) occurred;
2. One or more UL BWP IDs on the source PSCell where LBT failure (e.g. LBT failure is detected in the PHY layer for source PSCell, or consistent LBT failure is detected in the MAC layer for source PSCell) occurred;
3. One or more UL BWP IDs on the target PSCell where LBT failure (e.g. LBT failure is detected in the PHY layer for target PSCell, or consistent LBT failure is detected in the MAC layer for target PSCell) occurred;
4. The number of the source PCell's UL BWPs where consistent LBT failure occurred, or, the total number of consistent LBT failures detected in the MAC for source PCell;
5. The number of the source PSCell's UL BWPs where consistent LBT failure occurred, or, the total number of consistent LBT failures detected in the MAC for source PSCell;
6. The number of the target PSCell's UL BWPs where consistent LBT failure occurred, or, the total number of consistent LBT failures detected in the MAC for target PSCell;
7. The number of LBT failures detected in the MAC for source PCell for each BWP, i.e. the number of LBT failures indications received from physical layer in the MAC for source PCell per BWP. For example, the number of LBT failures on different BWPs in source PCell during RACH procedure, during the UL transmission on PUSCH, during the UL transmission on PCH, and/or during semi-persistent scheduled (SPS) transmission;
8. The number of LBT failures detected in the MAC for source PSCell for each BWP, i.e. the number of LBT failure indications received from physical layer in the MAC for source PSCell per BWP. For example, the number of LBT failures on different BWPs in source PSCell during RACH procedure, during the UL transmission on PUSCH, during the UL transmission on PCH, and/or during semi-persistent scheduled (SPS) transmission;
9. The number of LBT failures detected in the MAC for target PSCell for each BWP, i.e. the number of LBT failure indications received from physical layer in the MAC for target PSCell per BWP. For example, the number of LBT failures on different BWPs in target PSCell during RACH procedure, during the UL transmission on PUSCH, during the UL transmission on PCH, and/or during semi-persistent scheduled (SPS) transmission;
10. A RSSI of the source PCell at one of the following occasions:
   i. when PSCell change/CPAC is executed;
   ii. when RACH towards target PSCell is successful;
   iii. when LBT failure is detected by the MAC for source PCell (i.e. consistent LBT failure occurred in anyone UL BWP on the source PCell); or
   iv. when LBT failure is detected by the RRC for source PCell (i.e. consistent LBT failure occurred in all UL BWPs on the source PCell);
11. A RSSI of the source PSCell at one of the following occasions:
   i. when PSCell change/CPAC is executed;
   ii. when RACH towards target PSCell is successful;
   iii. when LBT failure is detected by the MAC for source PSCell (i.e. consistent LBT failure occurred in anyone UL BWP on the source PSCell), or
   iv. when LBT failure is detected by the RRC for source PSCell (i.e. consistent LBT failure occurred in all UL BWPs on the source PSCell);
12. A RSSI of the target PSCell at one of the following occasions:
   i. when PSCell change/CPAC is executed;
   ii. when RACH towards target PSCell is successful;
   iii. when LBT failure is detected by the MAC for target PSCell (i.e. consistent LBT failure occurred in anyone UL BWP on the target PSCell), or
   iv. when LBT failure is detected by the RRC for target PSCell (i.e. consistent LBT failure occurred in all UL BWPs on the target PSCell);
13. A channel occupancy of the source PCell at one of the following occasions:
   i. when PSCell change/CPAC is executed;
   ii. when RACH towards target PSCell is successful;
   iii. when LBT failure is detected by the MAC for source PCell (i.e. consistent LBT failure occurred in anyone UL BWP on the source PCell), or
   iv. when LBT failure is detected by the RRC for source PCell (i.e. consistent LBT failure occurred in all UL BWPs on the source PCell);
14. A channel occupancy of the source PSCell at one of the following occasions:
   i. when PSCell change/CPAC is executed;
   ii. when RACH towards target PSCell is successful;
   iii. when LBT failure is detected by the MAC for source PSCell (i.e. consistent LBT failure occurred in anyone UL BWP on the source PSCell); or
   iv. when LBT failure is detected by the RRC for source PSCell (i.e. consistent LBT failure occurred in all UL BWPs on the source PSCell); or
15. A channel occupancy of the target PSCell at one of the following occasions:
   i. when PSCell change/CPAC is executed;
   ii. when RACH towards target PSCell is successful;
   iii. when LBT failure is detected by the MAC for target PSCell (i.e. consistent LBT failure occurred in anyone UL BWP on the target PSCell); or
   iv. when LBT failure is detected by the RRC for target PSCell (i.e. consistent LBT failure occurred in all UL BWPs on the target PSCell).

The present disclosure also proposes applying the successful handover report for normal handover, Dual Active Protocol Stack Hand Over (DAPS HO), conditional handover (CHO) in NR-U. The NR-U related triggering condition(s) for successful handover report and NR-U related information included in the successful handover report can also be considered. When considering triggering conditions for generating a successful handover report, the triggering conditions for generating a successful handover report can be similar to the above triggering conditions for generating a successful PSCell change report, but the parameters relating to “source PSCell” is replaced by “source PCell”, and the parameters relating to “target PSCell” is replaced by “target PCell”.

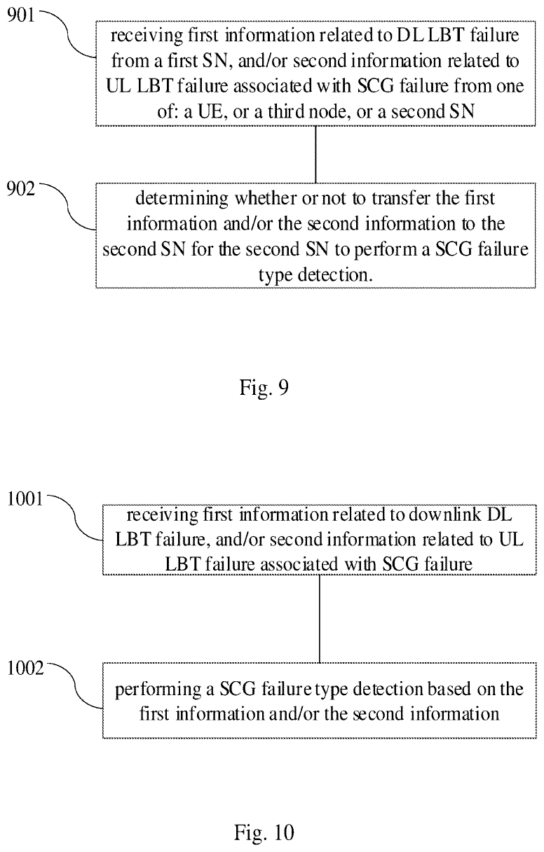

FIG. 9 illustrates a method performed by a MN for wireless communication in NR-U according to some embodiments of the present disclosure.

In operation 901, the MN receives first information related to DL LBT failure from a first SN, and/or second information related to UL LBT failure associated with SCG failure from one of: a UE, or a third node, or a second SN. The first information may include information associated with DL LBT failure, or information associated with NR-U at target SN side. For example, in operation 705 in FIG. 7, the MN receives the information associated with DL LBT failure from the target SN.

The second information related to UL LBT failure associated with SCG failure may include the SCG failure related information associated with NR-U. For example, in operation 202 in FIG. 2, the MN receives SCG failure related information associated with NR-U from the UE, in operation 503 in FIG. 5, the MN receives SCG failure related information associated with NR-U from the RN, and in operation 603 in FIG. 6, the MN receives SCG failure related information associated with NR-U from the S-SN.

In operation 902, the MN determines whether or not to transfer the first information and/or the second information to the second SN for the second SN to perform a SCG failure type detection. For example, in operation 203 in FIG. 2, the MN transfers the SCG failure related information associated with NR-U from the UE to the S-SN, for the S-SN to perform a SCG failure type detection.

In some embodiments, the MN transfers the first information and/or the second information to the second SN in the case that a failure occurred in PSCell change procedure or CPAC procedure initiated by the second SN. For example, in operation 203 in FIG. 2, the MN transfers the SCG failure related information associated with NR-U from the UE to the S-SN, because a PSCell change/CPAC/SCG failure occurred in a PSCell change procedure or CPAC procedure initiated by the S-SN.

In some embodiments, the MN performs the SCG failure type detection based on the first information and/or the second information in the case that the PSCell change/CPAC/SCG failure occurred in PSCell change procedure or CPAC procedure initiated by the MN. For example, in operation 403 in FIG. 4, the PSCell change/CPAC/SCG failure occurred in a PSCell change procedure or CPAC procedure initiated by the MN, and the MN performs the SCG failure type detection based on the first information and/or the second information.

In some embodiments, the MN transmits a first message to the first SN to inform that SCG failure occurred due to LBT failure. For example, in operation 207 in FIG. 2, the MN transmits an XnAP message to the target SN, to inform the target SN that SCG failure occurred due to LBT failure.

In some embodiments, the MN receives third information related to UL LBT failure associated with MCG failure from the second SN or the third node; and performs the SCG failure type detection and MCG failure type detection based on the second information and the third information, or based on the first information and the third information. The third information may include the MCG failure related information, and the second SN may include the source SN or the last serving SN, and the third node may include the re-established node. For example, in operation 603 in FIG. 6, the MN may receive MCG failure related information from the S-SN, and in operation 503 in FIG. 5, the MN may receive MCG failure related information from the RN. In operation 504 in FIG. 5, the MN may perform the SCG failure type detection and MCG failure type detection based on the SCG failure related information and the MCG failure related information both received from the RN, or in operation 604 in FIG. 6, the MN may perform the SCG failure type detection and MCG failure type detection based on the SCG failure related information and the MCG failure related information both received from the S-SN.

In some embodiments, the MN modifies LBT related configurations associated with MCG and/or transmits a first message to the first SN to inform that SCG failure occurred due to LBT failure. For example, in operation 804 in FIG. 8, the MN modifies NR-U/LBT related configurations associated with MCG and/or in operation 805, the MN transmits a first message to the target SN to inform that SCG failure occurred due to LBT failure.

In some embodiments, the MN receives a second message from the first SN regarding which node initiates the PSCell change procedure or the CPAC procedure; and the MN may transmit a first response to the first SN indicating a SN initiates PSCell change procedure or the CPAC procedure, wherein the first information is received from the first SN after transmitting the first response; or a second response to the first SN indicating that the MN initiates PSCell change procedure or the CPAC procedure.

In some embodiments, the MN receives a second message from the first SN indicating that LBT related configurations associated with SCG have been modified. For example, in operation 803 in FIG. 8, the MN may receive a message from the target SN, informing the MN that the target SN has modified the NR-U/LBT related configurations associated with target SCG.

In some embodiments, the first information includes at least one of the following:
1. a 1^{st} indication indicating that PSCell change failure or CPAC failure occurred due to LBT failure at the first SN, or due to New Radio Unlicensed (NR-U) channel(s) in target PSCell managed by the first SN are unavailable;
2. a PSCell change or CPAC failure type;
3. a 2^{nd} indication indicating that LBT related configurations associated with SCG needs to be modified;
4. information associated with NR-U channel(s) which are unavailable;
5. information associated with LBT events in target PSCell;
6. a Received Signal Strength Indicator (RSSI) of the target PSCell when LBT fails or when the NR-U channels in target PSCell are unavailable; or
7. a channel occupancy of the target PSCell when LBT fails or when the NR-U channels in target PSCell are unavailable.

In some embodiments, the second information includes at least one of the following:
1. A 3^{rd} indication indicating that PSCell change failure or CPAC failure occurs due to LBT failure;
2. A PSCell change or CPAC failure type;
3. One or more UL Bandwidth Part (BWP) IDs on the target PSCell where LBT failure occurs;
4. The number of target PSCell's UL BWPs where consistent LBT failure occurs;
5. The number of LBT failures detected in a MAC entity for target PSCell for each BWP;
6. A RSSI of the target PSCell; or
7. A channel occupancy of the target PSCell.

In some embodiments, the third information includes at least one of the following:
1. A 4^{th} indication indicating that MCG failure occurs due to LBT failure;
2. A MCG failure type;
3. One or more UL BWP IDs on the source PCell where LBT failure occurs;
4. The number of source PCell's UL BWPs where consistent LBT failure occurs;
5. The number of LBT failures detected in a MAC entity for source PCell for each BWP;
6. A RSSI of the source PCell; or
7. A channel occupancy of the source PCell.

FIG. 10 illustrates a method performed by a SN for wireless communication in NR-U according to some embodiments of the present disclosure.

In operation 1001, the SN receives first information related to DL LBT failure, and/or second information related to UL LBT failure associated with SCG failure; and in operation 1002, the SN performs a SCG failure type detection based on the first information and/or the second information. The SN may include the source SN or the last serving SN. For example, in operation 203 in FIG. 2, the source SN receives the SCG failure related information associated with NR-U, and in operation 204, the source SN performs a SCG failure type detection based on the SCG failure related information associated with NR-U; in operation 706 in FIG. 7, the source SN receives the information associated with DL LBT failure, and in operation 707, the source SN performs a SCG failure type detection based on the information associated with DL LBT failure.

In some embodiments, the SN transmits a first message to a second SN to inform that SCG failure occurred due to LBT failure; or transmits the first message to a master node to inform that SCG failure occurred due to LBT failure or to indicate the master node to inform the second SN that SCG failure occurred due to LBT failure. For example, in operation 205 in FIG. 2, the source SN transmits an XnAP message to the target SN to inform that SCG failure occurred due to LBT failure.

In some embodiments, the SN transmits transmit third information related to UL LBT failure associated with MCG failure to a master node. For example, in operation 603 in FIG. 6, the source SN transmits the MCG failure related information associated with NR-U to the MN.

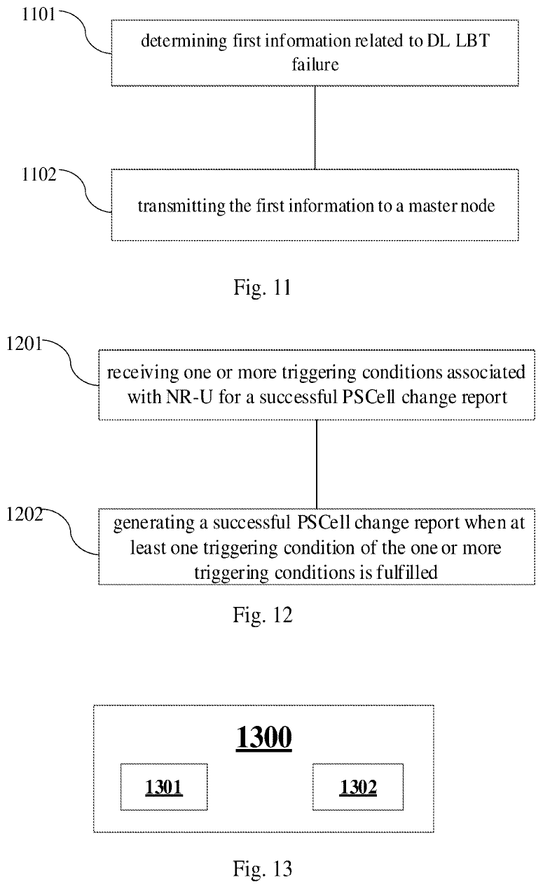

FIG. 11 illustrates a method performed by another SN for wireless communication in NR-U according to some embodiments of the present disclosure.

In operation 1101, the SN determines first information related to DL LBT failure; in operation 1102, the SN transmits the first information to a master node. The SN may include the target SN. In operation 801 in FIG. 8, the target SN determines the information related to DL LBT failure, and in operation 803, the target SN transmits the information related to DL LBT failure to the MN.

In some embodiments, the SN modifies LBT related configurations associated with SCG; and/or the SN transmits a first message to the master node indicating that the LBT related configurations associated with SCG of the node are modified. For example, in operation 802, the target SN modifies the LBT related configurations associated with target SCG, and optionally, the target SN transmits an XnAP message to the master node indicating that the LBT related configurations associated with target SCG of the node are modified.

In some embodiments, the SN receives a second message indicating that SCG failure occurred due to LBT failure. For example, in operation 805, the target SN receives an XnAP message from the MN, indicating that SCG failure occurred due to LBT failure.

In some embodiments, the SN transmits a third message to a MN regarding which node initiates the PSCell change procedure or the CPAC procedure; and receives a first response indicating that a second SN initiates PSCell change procedure or the CPAC procedure, wherein the first information is transmitted to the master node after receiving the first response; or a second response indicating that the MN initiates PSCell change procedure or the CPAC procedure.

FIG. 12 illustrates a method performed by a UE for wireless communication in NR-U according to some embodiments of the present disclosure.

In operation 1201, the UE may receive one or more triggering conditions associated with NR-U for a successful PSCell change report; and in operation 1202, the UE may generate a successful PSCell change report when at least one triggering condition of the one or more triggering conditions is fulfilled.

In some embodiment, the one or more triggering conditions includes at least one of the following:
1. LBT failure occurs in at least one UL BWP on a source PCell;
2. LBT failure occurs in at least one UL BWP on a source PSCell;
3. LBT failure occurs in at least one UL BWP on a target PSCell;
4. a 1^{st} number of source PCell's UL BWPs where consistent LBT failure occurs is higher than a 1^{st} threshold;
5. a 2^{nd} number of source PSCell's UL BWPs where consistent LBT failure occurs is higher than a 2^{nd} threshold;
6. a 3^{rd} number of target PSCell's UL BWPs where consistent LBT failure occurs is higher than a 3^{rd} threshold;
7. a 4^{th} number of LBT failure indications received from physical layer in the MAC per BWP for source PCell is higher than a 4^{th} threshold;
8. a 5^{th} number of LBT failure indications received from physical layer in the MAC per BWP for source PSCell is higher than a 5^{th} threshold;
9. a 6^{th} number of LBT failure indications received from physical layer in the MAC per BWP for target PSCell is higher than a 6^{th} threshold;
10. a RSSI of the source PCell is higher than a 7^{th} threshold;
11. a RSSI of the source PSCell is higher than a 8^{th} threshold;
12. a RSSI of the target PSCell is higher than a 9^{th} threshold;
13. a channel occupancy of the source PCell is higher than a 10^{th} threshold;
14. a channel occupancy of the source PSCell is higher than a 11^{th} threshold; or
15. a channel occupancy of the target PSCell is higher than a 12^{th} threshold.

In some embodiment, the successful PSCell change report includes at least one of the following:
1) one or more UL BWP IDs on the source PCell where LBT failure occurs;
2) one or more UL BWP IDs on the source PSCell where LBT failure occurs;
3) one or more UL BWP IDs on the target PSCell where LBT failure occurs;
4) a 1^{st} number of source PCell's UL BWPs where consistent LBT failure occurs;
5) a 2^{nd} number of source PSCell's UL BWPs where consistent LBT failure occurs;
6) a 3^{rd} number of target PSCell's UL BWPs where consistent LBT failure occurs
7) a 4^{th} number of LBT failure indications received from physical layer in the MAC for source PCell for each BWP;
8) a 5^{th} number of LBT failure indications received from physical layer in the MAC for source PSCell for each BWP;
9) a 6^{th} number of LBT failure indications received from physical layer in the MAC for target PSCell for each BWP;
10) a RSSI of the source PCell;
11) a RSSI of the source PSCell;
12) a RSSI of the target PSCell;
13) a channel occupancy of the source PCell;
14) a channel occupancy of the source PSCell; or
15) a channel occupancy of the target PSCell.

FIG. 13 illustrates a simplified block diagram of an exemplary apparatus 1300 according to some embodiments of the present disclosure. The apparatus 1300 may be or include at least a part of a UE, or other device with similar functionality.

As shown in FIG. 13, the apparatus 1300 may include a transceiver 1301, and a processor 1302. It is contemplated that the apparatus 900 may include other components not shown in FIG. 13.

The transceiver 1301 and the processor 1302 can be configured to perform any of the methods described in the present disclosure, for example, the method described with respect to any of FIGS. 9-12.

For example, the transceiver 1301 may receive first information related to DL LBT failure from a first SN, and/or second information related to UL LBT failure associated with SCG failure from one of: a UE, or a third node, or a second SN; and the processor may determine whether or not to transfer the first information and/or the second information to the second SN for the second SN to perform a SCG failure type detection. In some embodiments, the transceiver 1301 may receive first information related to DL LBT failure, and/or second information related to UL LBT failure associated with SCG failure, and the processor 1302 may perform a SCG failure type detection based on the first information and/or the second information.

In some embodiments, the processor 1302 may determine first information related to DL LBT failure; and the transceiver 1301 may transmit the first information to a master node. The SN may include the target SN.

In some other embodiments, the transceiver 1301 may receive one or more triggering conditions associated with NR-U for a successful PSCell change report; and the processor 1302 may generate a successful PSCell change report when at least one triggering condition of the one or more triggering conditions is fulfilled.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A master node for wireless communication, comprising:
at least one memory; and
at least one processor coupled with the at least one memory and configured to cause the master node to:
receive first information related to downlink (DL) listen before talk (LBT) failure from a first secondary node (SN), and/or second information related to uplink (UL) LBT failure associated with secondary cell group (SCG) failure from one of a user equipment (UE), a third node, or a second SN; and
determine whether or not to transfer the first information and/or the second information to the second SN for the second SN to perform a SCG failure type detection.

2. The master node of claim 1, wherein the at least one processor is further configured to cause the master node to:
transfer the first information and/or the second information to the second SN in a case that a failure occurred in primary secondary cell (PSCell) change procedure or conditional PSCell Addition/Change (CPAC) procedure initiated by the second SN.

3. The master node of claim 1, wherein the at least one processor is further configured to cause the master node to:
perform the SCG failure type detection based on the first information and/or the second information in a case that a failure occurred in primary secondary cell (PSCell) change procedure or conditional PSCell Addition/Change (CPAC) procedure initiated by the master node.

4. The master node of claim 3, wherein the at least one processor is further configured to cause the master node to:
transmit a first message to the first SN to inform that SCG failure occurred due to LBT failure.

5. The master node of claim 1, wherein the at least one processor is further configured to cause the master node to:
receive a second message from the first SN regarding which node initiates a primary secondary cell (PSCell) change procedure or a conditional PSCell Addition/Change (CPAC) procedure; and
transmit
a first response to the first SN indicating a SN initiates the PSCell change procedure or the CPAC procedure, wherein the first information is received from the first SN after transmitting the first response; or
a second response to the first SN indicating that the master node initiates the PSCell change procedure or the CPAC procedure.

6. The master node of claim 1, wherein the at least one processor is further configured to cause the master node to:
receive a second message from the first SN indicating that LBT related configurations associated with SCG have been modified.

7. The master node of claim 1, wherein the first information includes at least one:
a first indication indicating that primary secondary cell (PSCell) change failure or conditional PSCell Addition/Change (CPAC) failure occurred due to LBT failure at the first SN, or due to one or more new radio unlicensed (NR-U) channels in a target PSCell managed by the first SN are unavailable;
a PSCell change or CPAC failure type;
a second indication indicating that LBT related configurations associated with SCG are to be modified;
information associated with one or more NR-U channels which are unavailable;
information associated with LBT events in the target PSCell;
a Received Signal Strength Indicator (RSSI) of the target PSCell when LBT fails or when the one or more NR-U channels in the target PSCell are unavailable; or
a channel occupancy of the target PSCell when LBT fails or when the NR-U channels in target PSCell are unavailable.

8. (canceled)

9. (canceled)

10. (canceled)

11. A first secondary node (SN) for wireless communication, comprising:
at least one memory; and
at least one processor coupled with the at least one memory and configured to cause the first SN to:
determine first information related to downlink (DL) listen before talk (LBT) failure; and
transmit the first information to a master node.

12. The first SN of claim 11, wherein the at least one processor is further configured to cause the first SN to at least one of:
modify LBT related configurations associated with secondary cell group (SCG); or
transmit a first message to the master node indicating that the LBT related configurations associated with SCG of the first SN are modified.

13. The first SN of claim 11, wherein the at least one processor is further configured to cause the first SN to:
receive a second message indicating that secondary cell group (SCG) failure occurred due to LBT failure.

14. The first SN of claim 11, wherein the at least one processor is further configured to cause the first SN to:
transmit a third message to the master node regarding which node initiates a primary secondary cell (PSCell) change procedure or a conditional PSCell Addition/Change (CPAC) procedure; and
receive
a first response indicating that a second SN initiates the PSCell change procedure or the CPAC procedure, wherein the first information is transmitted to the master node after receiving the first response; or
a second response indicating that the master node initiates the PSCell change procedure or the CPAC procedure.

15. The first SN of claim 11, wherein the first information includes at least one of:
a first indication indicating that primary secondary cell (PSCell) change failure or conditional PSCell Addition/Change (CPAC) failure occurred due to LBT failure at the first SN, or due to one or more new radio unlicensed (NR-U) channels in a target PSCell managed by the first SN are unavailable;
a PSCell change or CPAC failure type;
a second indication indicating that LBT related configurations associated with SCG are to be modified;
information associated with one or more NR-U channels which are unavailable;
information associated with LBT events in the target PSCell;
a Received Signal Strength Indicator (RSSI) of the target PSCell when LBT fails or when the one or more NR-U channels in the target PSCell are unavailable; or
a channel occupancy of the target PSCell when LBT fails or when the NR-U channels in target PSCell are unavailable.

16. A user equipment (UE) for wireless communication, comprising:
at least one memory; and
at least one processor coupled with the at least one memory and configured to cause the UE to:
receive one or more triggering conditions associated with new radio unlicensed (NR-U) for a successful primary secondary cell (PSCell) change report; and
generate a successful PSCell change report when at least one triggering condition of the one or more triggering conditions is fulfilled.

17. The UE of claim 16, wherein the one or more triggering conditions include at least one of:
listen before talk (LBT) failure occurs in at least one uplink (UL) bandwidth part (BWP) on a source primary cell (PCell);
LBT failure occurs in at least one UL BWP on a source PSCell;
LBT failure occurs in at least one UL BWP on a target PSCell;
a first number of source PCells that have UL BWPs where consistent LBT failure occurs is higher than a first threshold;
a second number of source PSCells that have UL BWPs where consistent LBT failure occurs is higher than a second threshold;
a third number of target PSCells that have UL BWPs where consistent LBT failure occurs is higher than a third threshold;
a fourth number of LBT failure indications received from physical layer in a media access control (MAC) per BWP for the source PCell is higher than a fourth threshold;
a fifth number of LBT failure indications received from physical layer in the MAC per BWP for the source PSCell is higher than a fifth threshold;
a sixth number of LBT failure indications received from physical layer in the MAC per BWP for the target PSCell is higher than a sixth threshold;
a Received Signal Strength Indicator (RSSI) of the source PCell is higher than a seventh threshold;
a RSSI of the source PSCell is higher than an eighth threshold;
a RSSI of the target PSCell is higher than a ninth threshold;
a channel occupancy of the source PCell is higher than a tenth threshold;
a channel occupancy of the source PSCell is higher than an eleventh threshold;
a channel occupancy of the target PSCell is higher than a twelfth threshold.

18. The UE of claim 16, wherein the successful PSCell change report includes at least one of:
one or more uplink (UL) bandwidth part (BWP) identifiers (IDs) on a source primary cell (PCell) where listen before talk (LBT) failure occurs;
one or more UL BWP IDs on a source PSCell where LBT failure occurs;
one or more UL BWP IDs on a target PSCell where LBT failure occurs;
a first number of source PCells that have UL BWPs where consistent LBT failure occurs;
a second number of source PSCells that have UL BWPs where consistent LBT failure occurs;
a third number of target PSCells that have UL BWPs where consistent LBT failure occurs
a fourth number of LBT failure indications received from physical layer in a media access control (MAC) for the source PCell for each BWP;
a fifth number of LBT failure indications received from physical layer in the MAC for the source PSCell for each BWP;
a sixth number of LBT failure indications received from physical layer in the MAC for the target PSCell for each BWP;
a Received Signal Strength Indicator (RSSI) of the source PCell;
a RSSI of the source PSCell;
a RSSI of the target PSCell;
a channel occupancy of the source PCell;
a channel occupancy of the source PSCell; or
a channel occupancy of the target PSCell.

19. A processor for wireless communication, comprising:
at least one controller coupled with at least one memory and configured to cause the processor to:
receive one or more triggering conditions associated with new radio unlicensed (NR-U) for a successful primary secondary cell (PSCell) change report; and
generate a successful PSCell change report when at least one triggering condition of the one or more triggering conditions is fulfilled.

20. The processor of claim 19, wherein the one or more triggering conditions include at least one of:
listen before talk (LBT) failure occurs in at least one uplink (UL) bandwidth part (BWP) on a source primary cell (PCell);
LBT failure occurs in at least one UL BWP on a source PSCell;
LBT failure occurs in at least one UL BWP on a target PSCell;
a first number of source PCells that have UL BWPs where consistent LBT failure occurs is higher than a first threshold;
a second number of source PSCells that have UL BWPs where consistent LBT failure occurs is higher than a second threshold;
a third number of target PSCells that have UL BWPs where consistent LBT failure occurs is higher than a third threshold;
a fourth number of LBT failure indications received from physical layer in a media access control (MAC) per BWP for the source PCell is higher than a fourth threshold;
a fifth number of LBT failure indications received from physical layer in the MAC per BWP for the source PSCell is higher than a fifth threshold;
a sixth number of LBT failure indications received from physical layer in the MAC per BWP for the target PSCell is higher than a sixth threshold;
a Received Signal Strength Indicator (RSSI) of the source PCell is higher than a seventh threshold;
a RSSI of the source PSCell is higher than an eighth threshold;
a RSSI of the target PSCell is higher than a ninth threshold;
a channel occupancy of the source PCell is higher than a tenth threshold;
a channel occupancy of the source PSCell is higher than an eleventh threshold;
a channel occupancy of the target PSCell is higher than a twelfth threshold.

21. The processor of claim 19, wherein the successful PSCell change report includes at least one of:
one or more uplink (UL) bandwidth part (BWP) identifiers (IDs) on a source primary cell (PCell) where listen before talk (LBT) failure occurs;
one or more UL BWP IDs on a source PSCell where LBT failure occurs;
one or more UL BWP IDs on a target PSCell where LBT failure occurs;
a first number of source PCells that have UL BWPs where consistent LBT failure occurs;
a second number of source PSCells that have UL BWPs where consistent LBT failure occurs;
a third number of target PSCells that have UL BWPs where consistent LBT failure occurs
a fourth number of LBT failure indications received from physical layer in a media access control (MAC) for the source PCell for each BWP;
a fifth number of LBT failure indications received from physical layer in the MAC for the source PSCell for each BWP;
a sixth number of LBT failure indications received from physical layer in the MAC for the target PSCell for each BWP;
a Received Signal Strength Indicator (RSSI) of the source PCell;
a RSSI of the source PSCell;
a RSSI of the target PSCell;
a channel occupancy of the source PCell;
a channel occupancy of the source PSCell; or
a channel occupancy of the target PSCell.
